(19) United States
(12) Patent Application Publication
(10) Pub. No.: US 2026/0151746 A1
(43) Pub. Date: Jun. 4, 2026

(54) APPARATUS AND METHOD FOR MIXING SMALL LIQUID VOLUMES, AND USE OF THE APPARATUS

(71) Applicant: leon-nanodrugs GmbH, Planegg (DE)

(72) Inventor: Frank STIENEKER, Planegg (DE)

(21) Appl. No.: 18/706,754

(22) PCT Filed: Nov. 3, 2022
(86) PCT No.: PCT/EP2022/080743

§ 371 Date: May 2, 2024

(30) Foreign Application Priority Data
Nov. 3, 2021 (EP) 21206216.0
Feb. 21, 2022 (EP) 22157837.0
Jul. 6, 2022 (EP) 22183341.1

(51) Int. Cl. B01F 23/40; B01F 23/45; B01F 23/70; B01F 25/00; B01F 25/23; B01F 35/213; B01F 35/214; B01F 35/221; B01F 35/51; B01F 35/53; B01F 35/71; B01F 101/22; B01F 101/44

(52) U.S. Cl. CPC B01F 23/49; B01F 23/45; B01F 23/483; B01F 23/708; B01F 25/23; B01F 35/213; B01F 35/2142; B01F 35/2211; B01F 35/51; B01F 35/53; B01F 35/712; B01F 35/71745; B01F 35/7179; B01F 2025/916; B01F 2101/22; B01F 2101/44; B01F 2215/0468; B01F 2215/0477

(57) ABSTRACT

An apparatus (1) for mixing two liquids is provided. The apparatus comprises a static mixer (2), and a first (6) and second (14) feed module for feeding the two liquids to the mixer. The feed modules comprise pressurisable chambers (7, 15) for accommodating flexible containers (8, 16) which hold the liquids to be mixed. The liquids are forced through the static mixer when the chambers comprising the flexible containers are pressurised. Pressurisation is achieved by pressurised gas stored in pressure reservoir chambers (11, 19) that are connectable to the chambers holding the flexible containers. Related methods of mixing two liquids are also provided.

### BACKGROUND OF THE INVENTION

Process automation as well as up-and downscaling of mixing processes are tasks regularly dealt with in various fields of biotechnology and medicine.

Systems for the production of mixed fluids or products based on combination of two or more components need a source of liquid raw material, supply lines, a chamber in which the mixing or reaction takes place and an outlet for harvesting the product. The chamber often represents the heart of such systems and can for example be bulky, like e.g. containers, or miniaturized, like in microfluidic approaches. However, setup of the system, conditions and the quality of the raw material also plays a decisive role in these processes.

One example of a discontinuous mixing system is the apparatus for mixing, storing and homogenizing liquids as disclosed in U.S. Pat. No. 7,784,997B2. It comprises a rigid container fitted with a non-invasive pump. The container encloses a single-use bag that has an orifice at the lower face used as an outlet for the liquid and further orifices on the top of the bag for the addition of various liquids in order to produce a mixture. One of the upper orifices is used for the liquid to return to the inside of the bag (with help of the pump) enabling a closed-circuit circulation. The system is intended for single-use and prevents the cleaning and sterilisation steps that are necessary when rigid tanks are used for the mixing. It is able to handle bags with a volume of 25 to 3000 l but is does not appear to be suitable for the production of small amount, like e.g. μl- or ml amounts.

EP1146959B1 discloses an apparatus for the continuous production of encapsulated therapeutic compounds that gives an example for a precisely controlled metering system. The apparatus comprises a lipid phase storage means and an aqueous phase storage means, a pressurised transfer means for transferring the phases to a mixing device that preferably is a static mixer. The apparatus of EP1146959B1 additionally comprises a pre-mixing system. The phases are transported from the means to the pre-mixing and mixing chamber with help of metering pumps driven by a motor. Since this system is a continuous system, it is able to produce higher amounts of the desired product.

Despite these and other solutions to mixing systems and methods, the need for methods and apparatuses for the production of small quantities of products which are fast, reliable and can be performed under standardized conditions is not fully met. This is especially true for applications in the field of personalised medicine.

It is thus an object of the present invention to provide apparatuses and methods for the production of mixed fluids or products based on combination of two or more components that are flexible in terms of adaptation to different kind of products as well as robust, fast and reliably producing the desired product. They also aim at providing a high-throughput approach. Further objects of the invention will be clear on the basis of the following description of the invention, examples and claims.

### SUMMARY OF THE INVENTION

According to a first aspect of the invention, an apparatus for mixing a first and a second liquid is provided. The apparatus comprises a static mixer and a first and a second feed module which are adapted for providing the first and the second liquid to the static mixer. The feed modules are characterised in that each of them comprises: a substrate chamber for holding a flexible container having an interior space for holding the first liquid or the second liquid, respectively; a conduit for providing fluid communication between the interior space of the flexible container and the first or the second inlet of the static mixer, respectively; a pressure reservoir chamber for holding a pressurised gas; a connector for providing fluid communication between the pressure reservoir chamber and the substrate chamber. The connector comprises a means for reversibly interrupting the fluid communication between the pressure reservoir chamber and the substrate chamber, wherein the means has an open state and a closed state, and wherein said fluid communication is for permitting a flow of pressurised gas from the pressure reservoir chamber to the substrate chamber such as to exert pressure on an external surface of the flexible container and to force the first or second liquid from the container into the conduit. Moreover, the connector and said means are arranged for achieving immediate pressure equilibration between the pressure reservoir chamber and the substrate chamber upon changing the state of said means from closed to open.

Further features of the apparatus are provided below in the detailed description of the invention.

In a further aspect, the invention provides a method of mixing a first liquid and a second liquid based on the use of the apparatus. In particular, the method comprises the steps of:
(aa) providing a first flexible container holding the first liquid, said first flexible container being housed in a first pressurisable chamber;
(bb) providing a second flexible container holding the second liquid, said second flexible container being housed in a second pressurisable chamber;
(cc) providing a static mixer having
   a first inlet for receiving the first liquid,
   a second inlet for receiving the second liquid, and
   an outlet for discharging a third liquid that results from mixing the first liquid and the second liquid;
(dd) pressurising the first and the second pressurisable substrate chamber by means of a pressurised gas which exerts pressure on an external surface of each of the first and the second pressurisable substrate chamber such as to force said first and said second liquid through the static mixer such as to mix said first and said second liquid; and
(ee) collecting the third liquid.

Again, further features and embodiments of the method are disclosed in the detailed description of the invention below.

### BRIEF DESCRIPTION OF THE DRAWINGS

FIG. 1 shows an example of the general setup of an apparatus according to the invention.

FIG. 2 shows an apparatus with valves between the interior space of the flexible container and the inlets of the static mixer.

FIG. 3 shows an apparatus with means for indicating the pressure and inlets for pressurised gas.

FIG. 4, which is not to scale, depicts an example of a jet impingement reactor that is useful as a static mixing device and for carrying out the method of the invention.

FIG. 5 depicts an example of a flexible container for holding a liquid substrate, e.g. a first or second liquid. In principle, such flexible container can also be used as a product container.

FIG. 6 shows an alternative embodiment of the apparatus.

FIG. 7 depicts an alternative version of the apparatus. In this case, the orientation of the apparatus is designed to effect, overall, an upward direction of liquid flow, i.e. against gravity, or from a lower position to a higher position. Moreover, two containers for receiving the third liquid are arranged, of which one may be used as product container and the other one as waste container.

FIG. 8 depicts another version of the apparatus, comprising a means for inline particle size measurement with a sensing window, an analyser and a controller which is in communication with means, such as pinch valves, for interrupting the fluid connection to the containers for receiving the third liquid.

FIG. 9 shows a schematic illustration of the overall relationship between the pressure (P) in a pressure reservoir chamber, the pressure (P) in a corresponding substrate chamber, and the flow rate (F) of a liquid as it is forced out from a flexible container accommodated in the substrate chamber over time (t) when conducting the method of the invention. The figure is not to scale and only uses arbitrary units.

### DETAILED DESCRIPTION OF THE INVENTION

In a first aspect, the present invention provides an apparatus for mixing a first liquid and a second liquid. The apparatus comprises (a) a static mixer, (b) a first feed module for providing the first liquid, and (c) a second feed module for providing the second liquid to the static mixer. The static mixer itself is characterised in that it exhibits a first inlet for receiving the first liquid, a second inlet for receiving the second liquid, and an outlet for discharging a third liquid that results from mixing the first liquid and the second liquid. Furthermore, each of the first and the second feed module comprises (i) a substrate chamber for holding a flexible container, said flexible container having an interior space for holding the first liquid or the second liquid, respectively; (ii) a conduit for providing fluid communication between the interior space of the flexible container and the first or the second inlet of the static mixer, respectively; (iii) a pressure reservoir chamber for holding a pressurised gas; and (iv) a connector for providing fluid communication between the pressure reservoir chamber and the substrate chamber, wherein said connector comprises a means for reversibly interrupting the fluid communication between the pressure reservoir chamber and the substrate chamber, wherein said fluid communication is for permitting a flow of pressurised gas from the pressure reservoir chamber to the substrate chamber such as to exert pressure on an external surface of the flexible container and to force the first or second liquid from the container into the conduit. The means for reversibly interrupting the fluid communication between the pressure reservoir chamber and the substrate chamber has an open state and a closed state. Moreover, the connector and said means are arranged for achieving immediate pressure equilibration between the pressure reservoir chamber and the substrate chamber upon changing the state of said means from closed to open.

The inventors have found that the apparatus as defined herein is surprisingly precise in controlling the flow of the first and second liquid into the static mixer at predetermined flow rates, and allows the highly reproducible processing of the two liquid substrates into a product, i.e. the third liquid composition. Moreover, it allows the aseptic processing of very small batches, and it avoids the dead volumes and ramp-up losses of larger-scale equipment for generating liquid stream, in particular equipment using pumps and flow- or pressure control systems. The use of gas pressure exerted on an external surface of a flexible container as a driving force for achieving a controlled flow of liquids from such flexible containers into a static mixer also avoids the initial fluid pressure oscillations that are associated with the use of pumps. This effect makes the claimed apparatus and process particularly useful for the preparation of small batches and for short processing times. This is particularly true for gas pressure that is provided abruptly by a pre-pressurised pressure reservoir chamber rather than a continuous flow of a pressurised gas. Moreover, as the pressurised gas does not get into contact with the liquid but rather with the exterior surface of the flexible container, it cannot contaminate the liquid.

In view of the absence of pumps and other peripheral hardware, the apparatus can be designed to be disposable, thus avoiding lengthy cleaning and sterilisation cycles.

In the context of the invention, a static mixer is any mixer or mixing device that does not rely on moving parts for performing a mixing process. An example of a very simple static mixing device is a T-piece. As a static mixing device is for mixing two liquids such as to generate a liquid mixture, i.e., a third liquid, it typically comprises at least two substrate inlets and a product outlet. These substrate inlets are in the context of the invention referred to as the first inlet for receiving the first liquid and the second inlet for receiving the second liquid.

A feed module, as used herein, should be understood as a group of apparatus components that are designed, adapted and/or configured to feed a substrate to the static mixer. According to the invention, the apparatus comprises at least two feed modules: a first one to provide the first liquid to the first inlet of the static mixer, and a second one to provide the second liquid to the second inlet. A principal aspect that characterises the present invention is the design and configuration of these feed modules.

More specifically, the feed modules are adapted to accommodate flexible containers in which the liquid substrates are initially provided and from which these are fed into the mixing device. As used herein, a flexible container means any container capable of holding a liquid material that has at least one flexible wall. In particular, the container exhibits a type of flexibility by which the internal volume or interior space of the container may be significantly reduced, as is the case of collapsible containers where the collapsibility results from the flexibility of the container wall(s), similar to infusion bags.

Each of the two feed modules comprises a substrate chamber, which is a pressurisable chamber, for holding such flexible container. For operating the apparatus and mixing the two liquids, the substrate chambers are pressurised to discharge—e.g. squeeze—the liquids out of the flexible containers and to feed the liquids to the mixing device. The pressurisation is achieved by pressurised gas which is initially contained in the pressure reservoir chamber of each feed module, and which is allowed to flow into the substrate chambers such as to exert pressure on an external surface of the flexible container for starting the mixing process.

As mentioned, the connector for providing fluid communication between the pressure reservoir chamber and the substrate chamber and the means for reversibly interrupting the fluid communication between the pressure reservoir chamber and the substrate chamber which has an open state and a closed state are arranged for achieving immediate pressure equilibration between the pressure reservoir chamber and the substrate chamber upon changing the state of said means from closed to open. As used in this context, the expression “immediate” means or very rapid, such as less than 1 or 2 seconds, and in particular very rapid in comparison with the duration of the flow of the respective liquid from the flexible container to the static mixer which is effected by such rapid pressure equilibration between the pressure reservoir chamber and the substrate chamber. In other words, the initial pressure equilibration occurs abruptly. Typically, the pressure equilibration only requires a fraction of a second and is already completed or nearly completed when the respective liquid initially reaches the static mixer.

The immediate pressure equilibration between the pressure reservoir chamber and the substrate chamber involves a rapid and significant pressure increase in the substrate chamber where the pressurised gas rather suddenly exerts a pressure on an external surface of the flexible container, and a corresponding rapid pressure decrease in the pressure reservoir chamber. As will be understood by a skilled person, the pressure equilibrium achieved by the immediate pressure equilibration is a dynamic equilibrium in that the pressure in the pressure reservoir chamber and the pressure in the substrate chamber, which will be essentially the same after equilibration, will slightly decrease over time as the respective liquid flows out of the flexible container, thus reducing the overall volume of the flexible container and increasing the gas space in the substrate chamber. In one of the preferred embodiments, no additional pressurised gas is supplied to the pressure reservoir chamber or to the apparatus, neither during pressure equilibration nor during the subsequent flow of liquid from the flexible container to the static mixer, so that the equilibrium pressure in the pressure reservoir chamber and in the substrate chamber only changes in response to the flow of the liquid out of the flexible container. In an alternative embodiment, a further amount of pressurised gas is supplied at a point in time after the flow of the liquid has started.

In some preferred embodiments, the total decrease of the equilibrium pressure caused by the flow of the liquid from the flexible container into the static mixer is not more than about 10% of the initial equilibrium pressure. In this way, the pressure decrease during the mixing process cannot substantially impact the mixing process itself. As the skilled person will understand, the total equilibrium pressure decrease during the mixing process can be minimised by e.g. selecting a pressure reservoir chamber having a large internal volume relative to the volume of liquid that is forced to flow from the flexible container into the static mixer. For example, the internal volume of the pressure reservoir chamber may be at least about 10 times the volume of the liquid initially held by the flexible container; or the internal volume of the pressure reservoir chamber may be at least about 15 times, or even about 20 times or more of the volume of the liquid initially held by the flexible container.

Immediate equilibration is achievable by changing the state of the means for reversibly interrupting the fluid communication between the pressure reservoir chamber and the substrate chamber from its closed state to its open state. As will be understood in this context, the closed state means an entirely closed state, such as the state of a fully closed valve which substantially prevents fluid flow, whereas the open state means a fully open state such as to allow substantially unrestricted fluid flow. In one of the preferred embodiments, the means for reversibly interrupting the fluid communication between the pressure reservoir chamber and the substrate chamber has only these two states, i.e. a fully closed state and a fully open state. In other words, in this embodiment, it does not have an intermediate state such as a pressure regulating function, or if it does, such intermediate state is not used when conducting the process described herein.

Accordingly, it is one of the preferred embodiments that neither the means for reversibly interrupting the fluid communication between the pressure reservoir chamber and the substrate chamber nor the connector in general comprises a pressure regulating member.

Optionally, the open state may also be characterised in that the means for reversibly interrupting the fluid communication between the pressure reservoir chamber and the substrate chamber in its open state has a fluid path for the pressurised gas having a relatively large cross-sectional area, such as at least about 1 mm², or at least about 2 mm², 3 mm², 4 mm² or even 5 mm², respectively.

The means for reversibly interrupting the fluid communication between the pressure reservoir chamber and the substrate chamber may be integrated within the connector, or it may arranged as part of an outlet of the pressure reservoir chamber or of an inlet of the substrate chamber via which the connector provides the fluid communication between the pressure reservoir chamber and the substrate chamber.

In one of the preferred embodiments, the means for reversibly interrupting the fluid communication between the pressure reservoir chamber and the substrate chamber is the sole means for controlling the flow of pressurised gas between the pressure reservoir chamber and the respective substrate chamber.

A particular advantage of the invention is that the pressure in the pressure reservoir chamber and the volume ratio of the pressure reservoir chamber to the substrate chamber of each feed module may be preselected such as to achieve a desired pressure in the substrate chamber and thereby a desired flow rate by which a given liquid is squeezed out from a given flexible container and fed to the mixing device. Consequently, the use of pumps or process controls relying on flow meters can be avoided. As generally known to the person skilled in the art, the internal pressure of two chambers that are put in fluid connection with one another (such as the pressure reservoir chamber and the substrate chamber upon opening the e.g. valve of the connector between these chambers) will become identical, and the resulting pressure in the chambers may be precisely calculated and predicted on the basis of the initial pressures in the chambers before establishing the fluid connection and the internal volumes of the chambers. The actual flow rate of a liquid that is discharged from a flexible container comprised in the substrate chamber will of course also depend on other parameters such as the viscosity of the liquid and the flow resistance of the fluid path downstream of the flexible container. For a given liquid and a given flow path, however, the pressure which is required to obtain a specific flow rate can easily be determined experimentally. Once it is known, the feed module may be readily configured to achieve such target pressure, i.e., by calculating and selecting the specific chamber volumes and the starting pressure of the pressure reservoir chamber. If the batch size changes and the volume of the flexible container and of the substrate chamber is changed, the feed module can be easily reconfigured to achieve the same target pressure and the same flow rate, e.g., by adapting the starting pressure or the internal volume of the pressure reservoir chamber. This versatility is another advantage of the invention.

Particularly useful embodiments are based on the selection of specific static mixing devices, chambers, valves, containers, pressure ranges and other features, as will be described below. Generally, and unless the context dictates otherwise, these preferences should be understood as combinable with one another.

In one of the preferred embodiments, the static mixer comprises or represents a T-piece mixer, a Y-piece mixer, a vortex mixer, a baffle-based static mixer, a microfluidic mixing device, a multi-inlet vortex mixer (MIVM), or a jet impingement reactor. As used herein, T-piece mixers and Y-piece mixers are mixing devices comprising a T-piece or Y-piece, respectively, and which function to bring together and mix two liquids in such T-piece or Y-piece. A static vortex mixer is typically a precision engineered device for the continuous mixing of liquids based on baffle-like structures that are shapes such as to create a vortex, which is a region in the liquid mixture in which the flow revolves around an axis which is parallel to the overall direction of flow. Accordingly, such vortex mixer may also be understood as a special type of a baffle-based static mixer. A microfluidic mixing device, as used in the context of the invention, is any static mixing device whose fluid conduits typically have a diameter of not more than 2 or 3 mm, and often below 1 mm, which may be designed to offer a relatively (compared to the diameter of the fluid conduits) large interfacial surface between the two liquid substrates, for example by dividing the fluid streams into pluralities of microfluidic streams before bringing the substrates into contact with one another. A multi-inlet vortex mixer (MIVM) is a special type of a static vortex mixer having more than 2 fluid inlets.

The function of jet impingement reactors involves the injection of two fluid streams, e.g., a first stream of the first liquid and a second stream of the second liquid to be mixed, through nozzles into a reactor cavity such that the streams collide in a turbulent mixing zone. Preferably, the first and the second stream are injected from directly opposite positions of the reactor, preferably such that the streams collide substantially frontally, i.e., in an angle of substantially about 180°. Examples of jet impingement reactors include confined impingement jet (CIJ) reactors and microjet reactors (MJR).

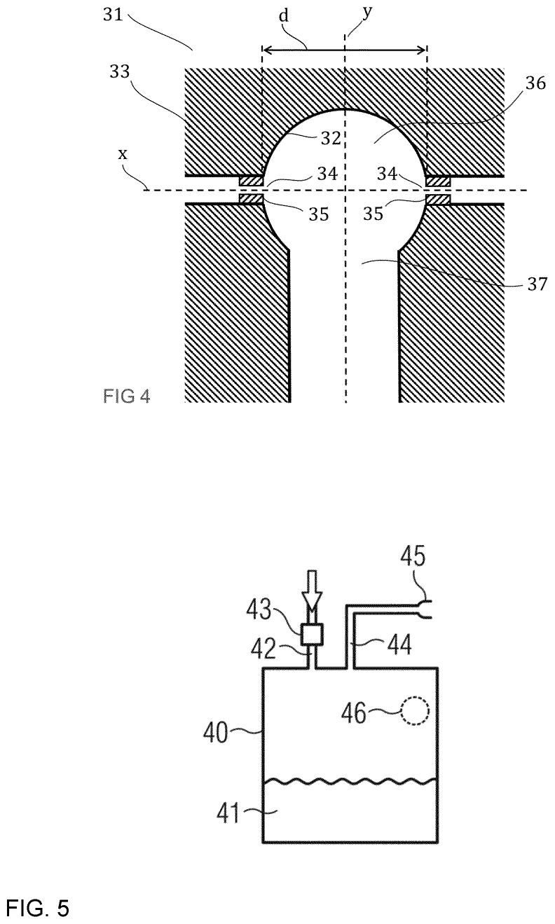

In one of the preferred embodiments (see also FIG. 4), the static mixer is a jet impingement reactor (31) having a mixing chamber (36) defined by an interior surface (32) of a mixing chamber wall (33), the mixing chamber (36) having a substantially spheroidal overall shape, wherein the mixing chamber (36) preferably comprises:
a first and a second fluid inlet (34), wherein the first and the second fluid inlet (34) are arranged at opposite positions on a first central axis (x) of the reaction mixing chamber (36) such as to point at one another, and wherein each of the first and the second fluid inlet (34) comprises a nozzle (35); and
a fluid outlet (37) arranged at a third position, said third position being located on a second central axis (y) of said chamber (36), the second central axis (y) being perpendicular to the first central axis (x); and
wherein the distance (d) between the nozzle (35) of the first fluid inlet (34) and the nozzle (35) of the second fluid inlet (34) is the same or smaller than the diameter of the mixing chamber (36) along the first central axis (x). Moreover, such jet impingement reactor may have further features as described in the co-pending European patent application 21192535.9, which is incorporated herein by reference.

As mentioned, the apparatus comprises a conduit for providing fluid communication between the interior space of the flexible container and the respective inlet of the static mixer. Specifically, the conduit of the first feed module provides a fluid connection between the interior space of the flexible container holding the first liquid and the first inlet, and the conduit of the second feed module provides a fluid connection between the interior space of the flexible container holding the second liquid and the second inlet. The conduit may, for example, comprise or represent a tube, which may be flexible, such as a tube made of an elastomeric (polymeric) material, or rigid, such as a metal tube.

In one embodiment, the conduit of the first and/or the second feed module comprises a means for-preferably reversibly-interrupting the fluid communication between the interior space of the flexible container and the respective inlet of the static mixer. Optionally, the means is a valve. If the conduit is a flexible tube, such as plastic tubing, the fluid communication may alternatively be interrupted initially by a tube clamp, in which case the respective fluid connection is generated by opening or removing the clamp, which allows the fluid to flow from the flexible container to the static mixer once the substrate chamber becomes pressurised.

In one embodiment, there is no means for interrupting the fluid connection arranged in the conduit of the first and/or the second feed module. The conduit may comprise a connection, e.g. achieved by the engagement of a connecting piece initially introduced as part of the outlet of the respective flexible container with a complementary connecting piece of a downstream part of the conduit that leads to the respective inlet of the static mixing device.

To initiate the pressurisation of the substrate chamber, the means for reversibly interrupting the fluid communication between the pressure reservoir chamber and the substrate chamber is opened or removed, such that the connector is open or free and generates said fluid connection. As used herein, the connector is any piece, conduit, pipe or tube capable of allowing pressurised gas to flow from the pressure reservoir chamber to the substrate chamber, or between these chambers. The means may be a clamp, if the connector material is flexible, or a valve. In one of the preferred embodiments, the means is a valve.

In order to achieve sufficient pressure in the substrate chamber without requiring the pressure reservoir chamber to be very highly pressurised before bringing the two chambers into fluid communication, e.g., by opening a valve of the connector, the pressure reservoir chamber may be designed to be relatively large. For example, the pressure reservoir chamber may have a larger volume than the substrate chamber with which it is in fluid communication. In this context, the volume should be understood as the internal volume of the respective chamber. Optionally, the volume of the pressure reservoir chamber may be twice as large as that of the respective substrate chamber, or even larger. In one embodiment, the ratio of the volume of the pressure reservoir chamber to the volume of the substrate chamber is at least about 10, and optionally in the range from about 10 to about 100, such as about 20 to about 50. For example, the pressure reservoir chamber may have an internal volume of about 5 to about 30 litres, and the corresponding substrate chamber may have an internal volume of about 0.3 to about 3 litres, or of about 0.3 to about 1 litre.

In a further embodiment, the pressure reservoir chamber has a substantially cylindrical or cylindroidal overall shape.

As will be understood by the person skilled in the art, the preparation of the apparatus for producing a batch of a liquid mixture (i.e. the third liquid) by mixing two liquid substrates (i.e. the first and the second liquid) would involve the filling of the pressure reservoir chambers of the first and the second feed module with a pressurised gas. The amount of pressurised gas to be used for this purpose, or the pressure that a pressure reservoir chamber should have at the beginning of the batch production, is selected with an eye on the volume of that chamber and of the corresponding substrate chamber, also taking into account the viscosity of the respective liquid, the flow resistance of the flow path and the desired flow rate. A typical initial pressure in a pressure reservoir chamber may, for example, be in the range of about 2 bar to 40 bar. Other pressures may also be used, depending on the selection of the pressurised gas that is used.

Moreover, the pressures may be selected such that the first and the second liquid are forced from the container into the respective conduit that directs it to the static mixer at a flow rate in the range from about 10 to about 200 ml/min.

In general, any technically suitable pressurised gas or gas mixture may be used. Examples of potentially useful gases include, without limitation, nitrogen, oxygen, air, inert gases such as helium, carbon dioxide, nitrous oxide, diethyl ether, n-butane, isobutane, heptafluoropropane, tetrafluoroethane, dichlorodifluoromethane, or propane. Among the preferred gases are nitrogen, air, and carbon dioxide.

The (pressurised) gas may be filled into the pressure reservoir chamber via its connector before the latter is affixed to, or connected with, the respective substrate chamber. In one of the preferred embodiments, the pressure reservoir chamber comprises an inlet for pressurised gas. This inlet may optionally comprise a means for closing the inlet, such as a valve. Moreover, the inlet is optionally independent from the connector. In this context, independent means functionally independent; structurally, it may be attached to, or associated with the connector. For example, the connector may have a three-way valve by which it is connected to the inlet for the pressurised gas. The valve may have a first position in which there is no fluid communication between either of the gas inlet, the pressure reservoir chamber, and the substrate chamber; a second valve position that opens a fluid communication only between the gas inlet and the pressure reservoir chamber; and a third position that opens a fluid communication only between the pressure reservoir chamber and the substrate chamber. In an alternative preferred embodiment, the inlet is positioned independently of the connector, and is equipped with a separate valve.

The inlet is preferably connectable with a source of pressurised gas, such as by a pressure-tight tube fitting. In a further embodiment, the inlet for pressurised gas is connected to a source of pressurised gas. Optionally, the connection to the source of pressurised gas is equipped with a pressure reducing means, such as a pressure regulator, e.g., a gas pressure-regulating valve.

The pressure reservoir chamber may comprise a means for indicating the pressure. This can be for example a manometer or other means to measure and indicate the pressure known in the art. Alternatively, the means for indicating the pressure can be attached to the connector for providing fluid communication between the pressure reservoir chamber and the substrate chamber.

All embodiments and optional features relating to the gas inlet described above may be used for one of the feed modules or for both feed modules. The apparatus may optionally have an asymmetric setup of the gas inlets, e.g., the gas inlet of the first or the second feed module can be attached to the reservoir chamber and the gas inlet of the second or first feed module can be attached to the connector.

As mentioned, the substrate chambers are adapted for holding a flexible container comprising the first or second liquid. In order to facilitate the insertion and/or removal of such flexible container, the substrate chamber of the first or the second feed module may comprise a means for it to be opened and closed. Preferably both the substrate chambers exhibit this feature. For example, the substrate chambers may comprise a two-piece wall or housing, e.g., a main part and a lid-like part, and a means for affixing the lid to the main part in a gas-tight manner.

In order to ensure the correct insertion of containers into substrate chambers, the flexible container holding the first and/or the second liquid may be tagged with an identification means. This identification means may, for example, be an RFID tag. In this case, it is advantageous to equip each substrate chamber with a sensor adapted for recognising the identification means, such as an RFID reader. Optionally, the RFID reader may communicate with a controller that enables or disables the operation of the apparatus, such that only upon correct insertion of the designated flexible containers the apparatus may be activated to perform a batch process.

According to a further preferred embodiment, the dimensions of each substrate chamber are selected such that its internal volume (or interior space) is only slightly larger than the overall, or external, volume of the flexible container that it should hold. For example, the flexible container in its initial dimensions, i.e., when filled with the liquid substrate and before a fluid communication with the static mixer is established, or when it is inserted into the substrate chamber, may fill at least about 30% of the total internal volume of the respective substrate chamber, or at least about 50%. As used herein, the total internal volume of the chamber-which is the basis of these percentages—should be understood as the total internal volume of the substrate chamber when empty. In further preferred embodiments, the initial overall volume of the flexible container is at least about 60%, or at least about 70%, or in the range from about 60% to about 95%, of the total internal volume of the substrate chamber.

At the same time, the dimensions of the two flexible containers that hold the first and the second liquid, respectively, may differ from one another. The results from the somewhat more typical situation according to which one of the two liquids must be provided at a larger volume, or flow rate, than the other liquid, for obtain a desired product. It is therefore another preferred embodiment that also the dimensions of the two substrate chambers that hold the flexible containers differ from one another. This applies in particular to the internal volumes of the chambers, which may be different from each other. In one embodiment, the difference between the internal volume of the substrate chamber of the first feed module and the internal volume of the substrate chamber of the second feed module is a factor in the range from about 1.5 to about 10, or from about 2 to about 5. In this context, the internal volume means the total internal volume of the respective chamber, i.e., when empty.

As mentioned, the flexible containers are for holding the liquid substrates, i.e., the first and the second liquid from which the third liquid is formed by mixing, using the apparatus of the invention. Preferably, the containers are flexible to the extent that they are at least partially collapsible. In other words, their internal volume may substantially change depending on the shape of the container wall(s) at a given moment.

In a further preferred embodiment, the flexible containers are flexible plastic bags, similar to infusion bags. The bags are preferably disposable. Preferably, the bags comprise the first or second liquid in sterile form. As indicated above, it is one of the advantages of the present invention that it enables the easy, quick and versatile aseptic manufacture of small batches, which is substantially facilitated by the use of sterile raw materials and disposable containers that do not have to be cleaned or sterilised between two batch production campaigns.

In one of the further preferred embodiments, the components of the apparatus are set up and/or oriented such that the liquids that are processed in the apparatus or obtained by the use of the apparatus have an overall direction of flow which is in the upward direction, i.e., against gravity. For example, the conduits for providing fluid communication between the interior space of the flexible containers and the first and the second inlet of the static mixer may be oriented such that their downstream ends that are in a higher position than their upstream ends. For the avoidance of doubt, the upstream end of a conduit is the end that is connected to the flexible container, and the downstream end of the conduit is connected to the first or second inlet of the static mixer. In this context, a higher position means being located above a comparatively lower position, with respect to a horizontal axis of the apparatus in its normal operational orientation.

Similarly, the static mixing device, or static mixer, may be oriented such that its outlet is in a higher position compared to its inlets. Also advantageous is this orientation of the static mixer in combination with the previously described orientation of the conduits. In this case, the entire overall liquid flow from the flexible containers to the outlet of the static mixer is in an upward direction. Such flow direction has been found to reduce or even avoid the entrapment of gas bubbles in the product, i.e. in the liquid mixture that represents the third liquid, in particular if the product contains surface-active compounds, as is the case when producing liposomes or lipid nanoparticles, which is described below in the context of the method according to the invention.

Optionally, also the inlet of the product container may be arranged in a higher position relative to the outlet of the static mixer.

According to a further preferred embodiment, the apparatus is entirely adapted for aseptic processing. This would include providing all substrate- or product-contacting surfaces in sterile form. It would further comprise the use of a sterile container for receiving the product prepared with the apparatus, i.e., the third liquid. Accordingly, it is preferred that the outlet of the static mixer is fluidically connectable, or actually connected, to a container for receiving the third liquid, wherein said container is optionally a flexible container. The connection may involve a sterile tube between the outlet of the static mixer and the container. This product container is also referred to as a first container for receiving the third liquid. For the avoidance of doubt, the expression “first container” does not imply any processing sequence; for example, if the apparatus is arranged with a first and a second container for receiving the third liquid, the process may be conducted such that the second container received an amount of the third liquid before the first container does.

The product container, or first container, may thus be a sterile, flexible bag that is aseptically connected with the outlet. In this context, aseptically connected means that the connection is sufficiently tight to prevent the contamination of the third liquid with e.g. airborne contaminants, in particular microbiological contaminants. It will be appreciated by the skilled person that these preferences will further facilitate aseptic small-scale batch manufacture in that the product can be easily removed from the apparatus, e.g., by clamping the connecting tube such as to seal the product container, and then cutting off the container upstream of the clamp.

Optionally, the connection between the outlet of the mixing device and the product container may comprise a filter, such as a sterile filter with a filter membrane having an effective pore diameter of 0.2 μm or 0.22 μm which is capable of removing microbiological contaminants from the third liquid. Of course, such filters may also optionally be used at other positions within the apparatus, such as at the inlets for pressurised gas, or within the conduits for providing fluid communication between the interior space of the flexible container holding the liquid substrates and the corresponding inlet of the static mixer. Such filters may also be at the inlets of the flexible container and provide for an aseptic filling of the substate into the container. These filters may be removable under sterile conditions, such that they can be removed when the containers are placed into the substrate chambers.

In a further preferred embodiment, the apparatus comprises a means for reversibly interrupting the fluid connection between the outlet of the static mixer and the first container for receiving the third liquid. For example, a pinch valve is suitable as a means for interrupting this fluid connection. Both electrically and pneumatically driven pinch valves are suitable in the context of carrying out the invention according to this embodiment.

In a further embodiment, the first container for receiving the third liquid comprises a first and a second fluid inlet, wherein the first fluid inlet is connectable to the outlet of the static mixer, and the second fluid inlet is adapted for filling a quantity of a liquid diluent into said first container. In this context, it is clear that “connectible” means fluidically connectable. This embodiment is advantageous in case it is desired to change the composition of the third liquid after its discharge from the static mixer by adding one or more further constituents. Typically, these one or more further constituents are added in liquid form, i.e. in the form of the liquid diluent. The second fluid inlet allows the introduction of such liquid diluent either before or after the first container receives the third liquid.

It should be noted that the liquid diluent may have other functions, or even have an entirely different key function than diluting the third liquid. For example, the liquid diluent may serve to adjust the pH of the product to a certain value, and it may for this purpose contain a pH-adjusting agent such as an acid, a base, a buffer salt, or a buffer system. Alternatively or in addition, the liquid diluent may comprise an isotonising agent such as sodium chloride, a sugar, a sugar alcohol or any other osmotically active compound. It may also comprise a lyophilisation aid, such as a sugar or sugar alcohol. Examples of suitable lyophilisation aids include, without limitation, trehalose, sucrose, glucose, mannitol and sorbitol. Any combinations of a pH-adjusting agent, an isotonising agents, and/or lyophilisation aid may also be used.

To facilitate the aseptic introduction of the liquid diluent into the container via one of the fluid inlets, an inline sterile filtration means may be arranged upstream of the respective fluid inlet. Such sterile filtration means will typically comprise a filter housing and a filter, such as a filter membrane having an effective pore diameter of e.g. 0.2 or 0.22 μm. After the aseptic introduction of the liquid into the container, sterile filtration means may be aseptically removed by melt clamping, or melt sealing the inlet upstream of the filtration means with simultaneous removal of the filtration means.

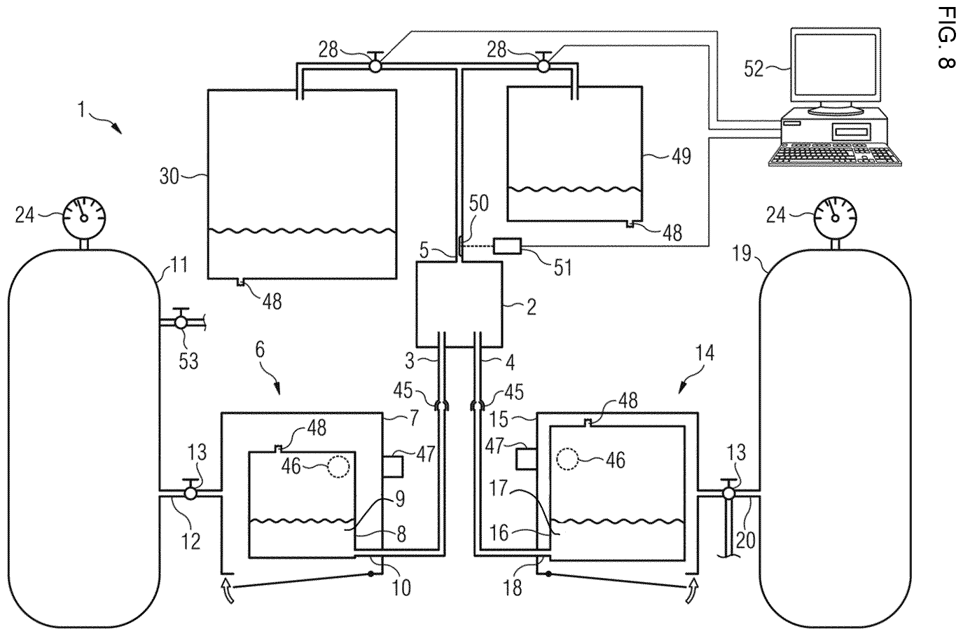

In addition to the product container, or first container, there may also be a second container for receiving the third liquid, i.e. an amount thereof. In other words, the outlet of the static mixer may be fluidically connectable to a second container for receiving the third liquid. Optionally, the second container is also a flexible container, such as a bag-like container. The outlet of the static mixer may be in fluid connection with both the first and the second container, for example, via a T-piece. An exemplary arrangement with two containers downstream of the static mixer is shown in FIG. 7.

One of the specific advantages of such arrangement is that the second container may be used for product waste, such as product obtained at the very initial phase of operating the apparatus or at the end of a batch process. This may be particularly useful if there is a risk that the product will achieve its target specification only after the initial phase or before the phase of the batch process.

In order to use both the first and the second container without interrupting the mixing process, a means for reversibly interrupting the fluid connection between the outlet of the static mixer and the second container for receiving the third liquid may be arranged. In one of the preferred embodiments, the apparatus is configured to have both a first and a second container for receiving the third liquid in fluid connection with the outlet of the static mixer, with a means for reversibly interrupting the fluid connection arranged upstream of each of the two containers, and downstream of the position where the fluid paths to the two containers divide, e.g. the T-piece if used.

Again, a pinch valve is suitable as a means for interrupting the fluid connection also between the static mixer outlet and the second container for receiving the product, which may represent a waste container. Both electrically and pneumatically driven pinch valves are suitable in the context of carrying out the invention according to this embodiment.

In one embodiment, the apparatus is configured to operate the pinch valves in response to a parameter measured in the third liquid generated by the mixing process. For example, if the third liquid is a liposome dispersion or a dispersion comprising lipid nanoparticles, an important product parameter could be represented by the particle size measured in the third liquid. The apparatus may therefore comprise a means for inline particle size measurement of the third liquid. In this context, inline means that the measurement is performed in real time during the mixing process without interrupting the process or the liquid flow, and without requiring the withdrawal of a sample of the third liquid for the purpose of measurement.

In one embodiment, the means for inline particle size measurement is located in a downstream portion of the static mixer, in the outlet of the static mixer, or downstream of and in fluid connection with the outlet of the static mixer. This should be understood such that at least the sensor which senses a signal from which the particle size is determined is located in one of the specified positions.

The means for inline particle size measurement may comprise a transparent sensing window, or measuring window, for allowing the transmission of optical signals from the third liquid to a sensor which is not in fluid communication with the third liquid. For example, the transparent measuring window may provided in the form of a capillary made of glass or plastic.

These features enable inline particle size measurement of the third liquid by means of optical methods such as light scattering or laser diffraction. Sensing a signal emitted or returned from the third liquid during its flow in the apparatus requires the presence of a transparent portion or window in the wall of any of the structures in which the third liquid flows. Such transparent portion or window may be present in a downstream portion of the static mixer, in the outlet of the static mixer, or in a downstream of and in fluid connection with the outlet of the static mixer, such as near the outlet of the static mixer, and—if two containers for receiving the third liquid are used—preferably upstream of the position where the fluid paths to these two containers separate. For example, a capillary made of glass or transparent plastic may form part of the structure that conducts the third liquid from the static mixer to the product container. Such capillary may also be part of the mixer itself. In fact, according to one of the embodiments of the invention, the static mixing device is made of glass or plastic. Also preferred is a static mixing device made of transparent glass or plastic. In this context, transparent means sufficiently transparent to allow the transmission of an optical signal for particle size measurement.

A skilled person will understand that the guidance provided herein which refers to the location of the means for inline particle size measurement primarily refers to the location where the measuring means, e.g. the sensor, interacts with the third fluid. Other components of the measuring means, such as a laser beam generator or the like, may be located at a certain distance to the specified locations.

In one embodiment, the transparent region, e.g. the capillary made of glass or plastic, has an interior surface that is coated with a layer of a material exhibiting low protein or nucleic acid binding. Alternatively, the capillary may be made of a type or grade of glass or plastic that exhibits low protein or nucleic acid binding.

As mentioned before, it may be desirable to arrange and orient the apparatus components such that the main overall direction of liquid flow during the mixing process is upwards, i.e. from a lower position to a higher position. Accordingly, in one embodiment, also the first and/or the second container for receiving the third liquid may be arranged in a higher position than the outlet of the static mixer such as to achieve an upward liquid flow downstream of the static mixer. More precisely, the inlet(s) of the first and/or the second container may be arranged in a higher position than the outlet of the static mixer to achieve an upward liquid flow direction from the static mixer to the product and/or waste container(s).

As there may be cases in which there is a need for further processing the third liquid, or the mixture obtained from combining the third liquid with the liquid diluent, it may be advantageous to use a first and/or second container which further comprises an outlet for withdrawing liquid. This applies particularly to the first container.

In a further aspect, the invention provides a method of mixing a first liquid and a second liquid such as to obtain a third liquid, the method essentially being characterised in that an apparatus as described above is used for the mixing of the liquids.

In a related embodiment, the method of mixing a first liquid and a second liquid comprises the steps of (aa) providing a first flexible container holding the first liquid, said first flexible container being housed in a first pressurisable substrate chamber; (bb) providing a second flexible container holding the second liquid, said second flexible container being housed in a second pressurisable substrate chamber; (cc) providing a static mixer having (i) a first inlet for receiving the first liquid, (ii) a second inlet for receiving the second liquid, and (iii) an outlet for discharging a third liquid that results from mixing the first liquid and the second liquid; (dd) pressurising the first and the second pressurisable substrate chamber independently by means of a pressurised gas which exerts pressure on an external surface of each of the first and the second pressurisable substrate chamber such as to force said first and said second liquid through the static mixer such as to mix said first and said second liquid; and (ee) collecting the third liquid. In this context, independently means that each pressurisable substrate chamber is independently pressurised by pressurised gas.

As a skilled person will understand, steps (aa), (bb) and (cc) may be conducted in any sequence, and optionally simultaneously. Steps (dd) and (ee) which follow steps (aa), (bb) and (cc), are conducted essentially simultaneously or with a substantial temporal overlap in that step (ee) may start and end with a small delay after the start and end of step (dd).

Step (ee) may advantageously comprise the collection of at least a portion of the third liquid in a first container for receiving the third liquid, said first container being arranged in fluid connection with the outlet of the static mixer.

As explained above, step (dd) may include a sudden, or abrupt, increase of pressure in each of the first and the second pressurisable substrate chamber. In a preferred embodiment, the pressure in the substrate chambers increases the from an initial pressure to a maximum process pressure within less than about 2 seconds, and preferably within less than about 1 seconds.

The abrupt nature of this pressure increase may also be described in relation to the duration of the subsequent step (ee) of collecting the third liquid. In preferred embodiments, the duration of the abrupt pressure increase in each of the first and the second pressurisable substrate chamber up to an initial equilibrium pressure is less than about 10 percent of the duration of step (ee), or less than about 5 percent, less than about 2 percent, or even less than about 1 percent of the duration of step (ee). As will be understood, the duration of step (ee) substantially reflects the time period during which the third liquid is actually generated in the static mixing device from the mixing of the first and the second liquid.

In further related embodiments, the initial pressure is approximately ambient pressure and the maximum process pressure is in the range from about 1 to 16 bar. Also preferred is a maximum process pressure in the range from about 2 to 12 bar, such as about 2 to 5 bar, or 4 to 8 bar, or 3 to 10 bar, respectively.

As mentioned, the pressurisation of the substrate chambers is achieved by means of a pressurised gas which exerts pressure on an external surface of the respective substrate chamber. In preferred embodiments, this pressurised gas is provided by a pressure reservoir chamber, as already described. In this case, the maximum process pressure in a substrate chamber corresponds to the initial equilibrium pressure that is reached upon the pressure equilibration between a pressure reservoir chamber and the respective substrate chamber.

Accordingly, in a related embodiment, each of the first and the second pressurisable substrate chamber is connected to a first and a second pressure reservoir chamber for holding the pressurised gas by means of a connector for providing fluid communication between the pressure reservoir chamber and the respective pressurisable substrate chamber, wherein a means for reversibly interrupting the fluid communication between each pressure reservoir chamber and the respective pressurisable substrate chamber is arranged, said means having an open state and a closed state; before conducting the pressurising step (dd), the respective pressure reservoir chamber is in a pressurised state such that its pressure is about 2 to 20 times higher than the pressure of the respective pressurisable substrate chamber, and the means for reversibly interrupting the fluid communication between the respective pressure reservoir chamber and the respective pressurisable substrate chamber is in the closed state. For the avoidance of doubt, the first pressurisable substrate chamber is connected to the first pressure reservoir chamber via a first connector, and the second pressurisable substrate chamber is connected to the second pressure reservoir chamber via a second connector. A first means is arranged for reversibly interrupting the fluid communication between the first pressure reservoir chamber and the first pressurisable substrate chamber, which means may be associated with the first connector, and a second means is arranged for reversibly interrupting the fluid communication between the second pressure reservoir chamber and the second pressurisable substrate chamber, which means may be associated with the second connector. There is no fluid communication between the first pressurisable substrate chamber or the first pressure reservoir chamber and the second pressurisable substrate chamber or the second pressure reservoir chamber. Moreover, there is no fluid contact between any pressurised gas and the first or the second liquid. As used in this context, the expression “respective” means “corresponding”, “connected” or “associated”.

In a further related embodiment, the pressurising step (dd) comprises the substeps of (i) changing the state of the means for reversibly interrupting the fluid communication between each pressure reservoir chamber and the respective pressurisable substrate chamber from closed to open and generating a pressure equilibrium between each pressure reservoir chamber and the respective pressurisable substrate chamber within a period of not more than about 2 seconds; and (ii) forcing essentially the entire amount of said first and said second liquid to flow from the respective flexible container through the static mixer such as to generate the third liquid over a period of at least about 5 seconds, and preferably of at least 10 seconds, such as from about 10 seconds to about 15 minutes. The skilled person will understand that the duration of liquid flow will vary depending on the flow rates but also the batch sizes.

In further embodiments, no additional pressurised gas is fed into any of the pressure reservoir chambers during steps (dd) and (ee). Accordingly, the equilibrium pressure is the main driving force causing the first and the second liquid to flow through the static mixer, in particular if there is no contribution by gravity to the liquid flow, depending on the geometric orientation of the apparatus. As mentioned, in some of the preferred embodiment, the apparatus is oriented such that the conduit for providing fluid communication between the interior space of the flexible container and the first or the second inlet of the static mixer comprises an upstream end connected to the flexible container and a downstream end connected to the first or second inlet of the static mixer, wherein the downstream end is in a higher position than the upstream end. In other words, at least the flexible container(s) and the static mixer are arranged such that the liquid flow occurs in an upward direction.

With respect to the optional or preferred features of the static mixer, the chambers and other device features, reference is made to the disclosure above. In other words, embodiments and preferences provided for the apparatus provided according to the invention are also applicable to the method, such that preferred embodiments of the method are characterised by the use of preferred apparatus features for performing the mixing of the two fluids. Moreover, optional and preferred process features have specifically been described in the context of the apparatus as appropriate for explaining its function.

For example, in one of the preferred embodiments, and as described above, the first container for receiving the third liquid, which may also be referred to as the product container, is configured to receive a liquid diluent either before or after receiving the third liquid. For filling the liquid diluent into the container, the container may—at least initially—comprise a further inlet and, associated with this inlet, a means for inline sterile filtration. Accordingly, the method of the invention may comprise a step of filling a liquid diluent into the first container before or after the third liquid is received in said first container, preferably through a further inlet of the container and a sterile filter that is associated with this inlet. The liquid diluent is preferably an aqueous liquid composition. As mentioned, it may comprise a pH-adjusting agent, an isotonising agent, a lyophilisation aid, or any combination thereof.

Regardless of whether the third liquid collected in the first (or product) container downstream of the static mixer is combined with a liquid diluent or not, further processing steps may follow, for example in order to further purify or characterise the product or to render it more stable and facilitate handling, storage, and shipment. Preferably, such further processing is also conducted under aseptic conditions.

For example, further processing may include a step of tangential flow filtration, chromatography, freezing or freeze drying of the third liquid collected according to step (ee) or a mixture of the third liquid with the liquid diluent. Tangential flow filtration or chromatography may be useful for the purpose of concentrating the product, e.g. in the sense that the concentration of any particles generated by the mixing of the first and the second liquid such as liposomes or lipid nanoparticles is increased; or for removing or reducing the concentration of certain solutes, such as free molecules of a biologically active ingredient, i.e. molecules that are not incorporated in liposomes or lipid nanoparticles. Freezing or freeze drying may be useful to convert the third liquid or the liquid mixture of the third liquid and the liquid diluent into a solid composition which can typically be stored for an increased period of time. These processes or process steps as such and their implementation are generally known to a skilled person. As described above, the apparatus may comprise a means for inline particle size measurement on the third liquid. Accordingly, it is also one of the preferred embodiments of the method of the invention to make use of this apparatus feature and conduct a step of performing an inline particle size measurement on the third liquid before said third liquid is received by the first container. In this manner it can be ensured that an important product parameter, i.e. a targeted particle size, is actually achieved by the product in form of the third liquid as it is collected in a product container. This embodiment is particularly relevant in the context of manufacturing small batches of liquid products that comprise liposomes or lipid nanoparticles.

The inline particle size measurement step may also be advantageous when working with a further preferred embodiment of the apparatus according to which a second container for receiving the third liquid is present. In terms of method features, this means that step (ee) may comprise collecting at least a further portion of the third liquid in a second container for receiving the third liquid, said second container being arranged in fluid connection with the outlet of the static mixer. The collecting of the portion or portions of the third liquid in the second container may be effected by interrupting the fluid connection between the outlet of the static mixer and the first container for receiving the third liquid.

For example, an initial portion of the third liquid as it is discharged from the static mixer through its outlet may be directed into the second container, which may function as a waste container, followed by directing a subsequent portion of the third liquid into the first container, which may function as product container. Optionally, a yet further subsequent portion of the third liquid may again be directed into the second container, e.g. towards the end of a batch production. In this manner, it is possible to selectively collect a fraction of the third liquid which excludes material generated during the start-up or trailing phase of the process and which therefore represent best the targeted product quality.

In another preferred embodiment, the apparatus features both the arrangement comprising a means for inline particle size measurement and the arrangement comprising a first and a second container for receiving the third liquid, and also exhibits means-such as pinch valves—for reversibly interrupting the fluid connection between the outlet of the static mixer and each of the first and the second container. Furthermore, this embodiment would also provide a means for controlling the e.g. pinch valves to interrupt or open the respective fluid connection in response to the particle size measurement.

In terms of the method of the invention, this apparatus arrangement and configuration may be used such that during steps (dd) and (ee), during which the mixing process is ongoing and the third liquid is generated and discharged from the static mixing device through its outlet, the inline particle size measurement is performed. Depending on the measured particle size, the pinch valves will be operated such that there is either an open fluid connection between the outlet and the first container which is used as product container, while the fluid connection to the second container is interrupted; or that there is an open fluid connection between the outlet and the second container which is used as waste container, while the fluid connection to the first container is interrupted.

In other words, according to this embodiment, the method comprises performing inline particle size measurement on the third liquid during steps (dd) and (ee); if the inline particle size measurement gives an undesirable result, collecting the third liquid in the second container for receiving the third liquid by interrupting the fluid connection between the outlet of the static mixer and the first container for receiving the third liquid; and if the inline particle size measurement gives a desirable result, collecting the third liquid in the first container for receiving the third liquid by interrupting the fluid connection between the outlet of the static mixer and the second container for receiving the third liquid.

For example, in the initial phase of steps (dd) and (ee), the particle size measured in the third liquid may not yet fulfil the pre-set target criteria such that the first amount of the third liquid should be directed to the waste container, which is achieved by the respective settings of the pinch valves. Upon reaching the desired particle size characteristics, the settings of the valves are changed and the third liquid is now directed into the product container.

The method of the invention may be used, for example, for making particles, such as micro- or nanoparticles of poorly water-soluble compounds by flash precipitation. For this purpose, one of the liquid substrates, for example the first liquid, may comprise an organic solution of the poorly soluble compound in a water-miscible solvent or solvent mixture; and the second liquid may represent an aqueous solution, such that the mixing of the two liquids according to the invention results in the precipitation of the poorly soluble compound in the form of micro- or preferably nanoparticles. Similarly, poorly soluble compounds that are ionisable may be precipitated as micro- or nanoparticles using the method of the invention by providing a first liquid which is an aqueous solution of the poorly soluble compound having a pH at which the compound is predominantly ionised and soluble, and a second liquid which represents an aqueous solution that due to its pH acts as an antisolvent to the poorly soluble compound.

In some embodiments, the poorly soluble compound is a biologically active agent, such as a drug substance, a vaccine or a diagnostic compound. Optionally, the first and/or the second liquid may comprise one or more polymers, and the process may be conducted such that polymeric particles comprising a biologically active ingredient are produced.

In a further preferred embodiment of the method of the invention, the first liquid comprises an organic solution of one or more lipids; the second liquid comprises an aqueous solution of a biologically active agent; such that lipid nanoparticles are formed by the mixing of the first and the second liquid, wherein the biologically active agent is associated with and/or encapsulated within the lipid nanoparticles.

Preferably, more than one lipid is used in the first liquid. For example, an organic (e.g. ethanolic) solution of a combination of lipids that are known to be useful for making lipid nanoparticles (LNPs) may be used. These lipids may include a cationic or cationisable lipid, a PEGylated lipid, a structural lipid, and cholesterol.

As used herein, and unless the context dictates otherwise, a cationic lipid is a lipid comprising a positive charge in an aqueous environment of any pH, such as a lipid having a quaternary nitrogen atom (i.e., an ammonium moiety); whereas a cationisable lipid is a lipid comprising a positive charge only in an aqueous environment of neutral or acidic pH, such as a lipid representing a primary, secondary or tertiary amine.

In specific embodiments, the cationic or cationisable lipid is selected from the group of N1-[2-((1S)-1-[(3-aminopropyl)amino]-4-[di(3-amino-propyl)amino]butylcarboxamido)ethyl]-3,4-di [oleyloxy]-benzamide (MVL5), N4-cholesteryl-spermine HCl salt (GL67), N-(4-carboxybenzyl)-N,N-dimethyl-2,3-bis(oleoyloxy) propan-1-aminium (DOBAQ), 1,2-distearoyl-3-dimethylammonium-propane (18:0 DAP), 1,2-dipalmitoyl-3-dimethylammonium-propane (16:0 DAP), 1,2-dimyristoyl-3-dimethylammonium-propane (14:0 DAP), 1,2-dioleoyl-3-dimethylammonium-propane (DODAP) (18:1 DAP), 1,2-dioleyloxy-3-dimethylaminopropane (DODMA), 1,2-di-O-octadecenyl-3-trimethylammonium propane (chloride salt) (DOTMA), 1,2-dioleoyloxy-3-trimethylammonium-propane (chloride salt) (18:1 TAP or DOTAP), 1,2-stearoyl-3-trimethylammonium-propane (chloride salt) (18:0 TAP), 1,2-dipalmitoyl-3-trimethyl-ammonium-propane (chloride salt) (16:0 TAP), 1,2-dimyristoyl-3-trimethyl-ammonium-propane (chloride salt) (14:0 TAP), dimethyldioctadecylammonium (bromide salt) (18:0 DDAB), 1,2-dimyristoleoyl-sn-glycero-3-ethylphosphocholine (Tf salt) (14:1 EPC Tf Salt), 1-palmitoyl-2-oleoyl-sn-glycero-3-ethylphosphocholine (chloride salt) (16:0-18:1 EPC Cl salt), 1,2-dioleoyl-sn-glycero-3-ethylphosphocholine (chloride salt) (18:1 EPC Cl salt), 1,2-distearoyl-sn-glycero-3-ethylphosphocholine (chloride salt) (18:0 EPC Cl salt), 1,2-dipalmitoyl-sn-glycero-3-ethylphosphocholine (chloride salt) (16:0 EPC Cl salt), 1,2-dimyristoyl-sn-glycero-3-ethylphosphocholine (chloride salt) (14:0 EPC Cl salt), 1,2-dilauroyl-sn-glycero-3-ethylphosphocholine (chloride salt) (12:0 EPC Cl salt), O,O′-ditetradecanoyl-N-(a-trimethylammonioacetyl) diethanolamine chloride (DC-6-14), 3ß-[N-(N′,N′-dimethylaminoethane)-carbamoyl]cholesterol hydrochloride (DC-cholesterol·HCl), 4-(dimethylamino)-butanoic acid, (10Z,13Z)-1-(9Z,12Z)-9,12-octadecadien-1-yl-10,13-nonadecadien-1-yl ester (D-Lin-MC3-DMA), ([(4-hydroxybutyl) azanediyl]di(hexane-6,1-diyl) bis(2-hexyldecanoate)) (ALC-0315), 1,1′-((2-(4-(2-((2-(bis(2-hydroxydodecyl)amino)ethyl) (2-hydroxydodecyl)amino)ethyl) piperazin-1-yl)ethyl) azanediyl)bis(dodecan-2-ol) (C12-200), cetyl-trimethyl ammonium bromide (CTAB), penta-amine N15-cholesteryloxycarbonyl-3,712-triazapentadecane-115-diamine (CTAP), bis-guanidinium-spermidine-Chol (BGSC), bis-guanidinium-tren-Chol (BGTC), N,N-distearyl-N-methyl-N-2 [N′-(N2-guanidino-L-lysinyl)]aminoethyl ammonium chloride (DSGLA), O-(2R-1,2-di-O-(1Z,9Z-octadecadienyl)-glycerol)-3-N-(bis-2-aminoethyl) carbamate) (BTCA), 1,2-dilinoleyloxy-3-dimethylaminopropane (DLinDMA), N-[6-amino-1-oxo-1-(N-tetradecylamino) hexan-(2S)-2-yl]-N′-{2-[N,N-bis(2-aminoethyl)-amino]ethyl}-2,2-ditetradecylpropandiamide (DiTT4), cholesteryloxypropan-1-amine (COPA), and cholesteryl-2-aminoethylcarbamate (CAEC). Optionally, the first liquid comprises a mixture of two or more of the above listed cationic or cationisable lipids. Cationic or cationisable lipids are capable of interacting with negatively charged oligo- and polynucleotides and support the association and/or encapsulation of such nucleotides in or with a lipid nanoparticle.

As used herein, PEG means polyethylene glycol, and a PEGylated lipid is a lipid that is conjugated with a PEG moiety. In specific embodiments, the PEGylated lipid is selected from the group of 1,2-dimyristoyl-rac-glycero-3-methoxypolyethylene glycol-2000 (DMG-PEG 2000), distearoyl-rac-glycerol-PEG2K (DSG-PEG 2000), 2 [(polyethylene glycol)-2000]-N,N-ditetradecylacetamid (ALC-0159), N-(carbonyl-methoxypolyethylenglycol 2000)-1,2-dimyristoyl-sn-glycero-3-phosphoethanolamine sodium salt (MPEG-2000-DMPE Na), N-(carbonyl-methoxypolyethylenglycol 750)-1,2-distearoyl-sn-glycero-3-phosphoethanolamine sodium salt (MPEG-750-DSPE), 1,2-distearoyl-sn-glycero-3-phosphoethanolamine-N-[amino (polyethylene glycol)-2000] (ammonium salt) (DSPE-PEG (2000)), 1,2-dipalmitoyl-sn-glycero-3-phosphoethanolamine-N-[methoxy (polyethylene glycol)-2000] (ammonium salt) (16:0 PEG2000 PE), 1,2-dimyristoyl-sn-glycero-3-phosphoethanolamine-N-[methoxy (polyethylene glycol)-2000] (ammonium salt) (14:0 PEG2000 PE), 1,2-dioleoyl-sn-glycero-3-phosphoethanolamine-N-[methoxy (polyethylene glycol)-2000] (ammonium salt) (18:1 PEG2000 PE), 1,2-distearoyl-sn-glycero-3-phosphoethanolamine-N-[methoxy (polyethylene glycol)-2000] (ammonium salt) (18:0 PEG2000 PE), 1,2-distearoyl-sn-glycero-3-phosphoethanolamine-N-[methoxy (polyethylene glycol)-5000] (ammonium salt) (18:0 PEG5000 PE), N-(carbonyl-methoxypolyethylenglycol 2000)-1,2-dipalmitoyl-sn-glycero-3-phosphoethanolamine sodium salt (MPEG-2000-DPPE Na). Optionally, the first liquid composition comprises a mixture of two or more of the above listed PEGylated lipids. In one of the preferred embodiments, the first liquid comprises only one PEGylated lipid. Optionally, the PEGylated lipid is the same as the cationic or cationisable lipid. In an alterative and more preferred embodiment, the first liquid comprises one PEGylated lipid which is not cationic or cationisable, and one cationic or cationisable which is not PEGylated.

The structural lipid is preferably a non-PEGylated zwitterionic lipid. In specific embodiments, the non-PEGylated zwitterionic lipid is selected from the group of 1,2-dimyristoyl-sn-glycero-3-phosphocholine (DMPC), 1,2-dioleoyl-sn-glycero-3-phosphoethanolamine (18:1 (49-cis) PE or DOPE), 1,2-Dipalmitoyl-sn-glycero-3-phosphate (sodium salt) (DPPA, Na), 1-palmitoyl-2-oleoyl-sn-glycero-3-phosphocholine (POPC), 1,2-dipalmitoyl-sn-glycero-3-phosphocholine (16:0 PC or DPPC), 1,2-distearoyl-sn-glycero-3-phosphocholine (DSPC), 1,2-dimyristoyl-sn-glycero-3-phosphatidylethanolamine (DMPE), 1-palmitoyl-2-oleoyl-sn-glycero-3-phosphatidylethanolamine (1,2-POPE), 1,2-dioleoyl-sn-glycerol-3-phosphatidylcholine (DOPC), and trans-2-aminoacyclohexanol (TACH). Optionally, the first liquid comprises a mixture of two or more of the above listed non-PEGylated zwitterionic lipids. In one of the preferred embodiments, it comprises only one non-PEGylated zwitterionic lipid.

It is further preferred that the first liquid comprises a water-miscible solvent in which the lipids are dissolved. The water-miscible solvent is preferably selected from ethanol, methanol, acetone, acetonitrile, acetic acid, formic acid, trifluoroacetic acid, acetaldehyde, butanol, ethylamine, and any combinations thereof. One of the particularly preferred water-miscible solvents is ethanol.

In a further preferred embodiment, the first liquid essentially consists of a solution of the one or more lipids in a water-miscible solvent selected from ethanol, methanol, acetone, acetonitrile, acetic acid, formic acid, trifluoroacetic acid, acetaldehyde, butanol, ethylamine, and any combinations thereof. In a specific embodiment, the first liquid composition essentially consists of a solution of the one or more lipids in ethanol.

In some embodiments, the first liquid composition comprises:
from 40 to 60 mol % of a cationic or cationisable lipid;
from 0.5 to 2 mol % of a PEGylated lipid;
from 5 to 20 mol % of a non-PEGylated zwitterionic lipid; and
from 30 to 50 mol % of cholesterol;
   wherein the percentages are based on the total content of lipids in the first liquid.

If the method is used to prepare lipid nanoparticles, it is further preferred that the biologically active agent is an oligo- or polynucleotide. According to another preferred embodiment, the oligo- or polynucleotide is an optionally modified mRNA molecule comprising a nucleic acid sequence encoding an antigen, in particular a tumour antigen, a viral antigen, a bacterial antigen, a fungal antigen, or a protozoal antigen.

A particular advantage of the apparatus according to the invention is that it enables the quick and flexible manufacture of small batches under aseptic conditions. After the manufacture of a batch, the apparatus is easily reconfigured and prepared for the manufacture of another batch of the same or a different material. No pumps are involved when causing the first and the second liquid to flow, mix and form the third liquid. There are few structures with direct product contact, and these may be easily replaced. Those parts that require sterilisation before the manufacture of a batch are easily sterilised.

For example, the method of the invention may include a step of sterilising the static mixer before step (dd) is conducted, i.e. before pressurizing the first and the second pressurisable chamber such as to force said first and said second liquid through the static mixer and to cause the mixing of the two liquid substrates. The sterilisation may be performed with any sterilisation method that is compatible with the material from which the mixing device is made. For example, sterilisation may be performed with steam. In one of the preferred embodiments, sterilisation is performed by gamma irradiation. This also applies in case the mixing device is made of glass or plastic, in particular if the mixing device of glass or plastic is a jet impingement reactor as described above in more detail.

According to a further aspect, the invention provides the use of a pressurised gas for forcing a first liquid to flow from a flexible container into a static mixer where said liquid is mixed with a second liquid such as to form a third liquid, wherein said pressurised gas is provided such as to abruptly exert a pressure of 1 bar to 16 bar on an outer surface of said flexible container without being in fluid communication with said first liquid.

Preferably, pressurised gas is also used in the same manner for forcing the second liquid to flow from a (second) flexible container into a static mixer. In one of the specific embodiments, the pressurised gas is provided such as to abruptly exert a pressure of 2 bar to 12 bar on an outer surface of said flexible container.

In some preferred embodiments, the static mixer is part of an apparatus as described above, and the use further involves one or more features described in the context of the method disclosed herein.

In a further aspect, the invention provides the use of the apparatus or of the method as described above for the production of lipid nanoparticles.

### DETAILED DESCRIPTION OF THE DRAWINGS

The drawings included in the present disclosure illustrate certain embodiments relating to the apparatus provided according to the invention. None of the following drawings are according to scale.

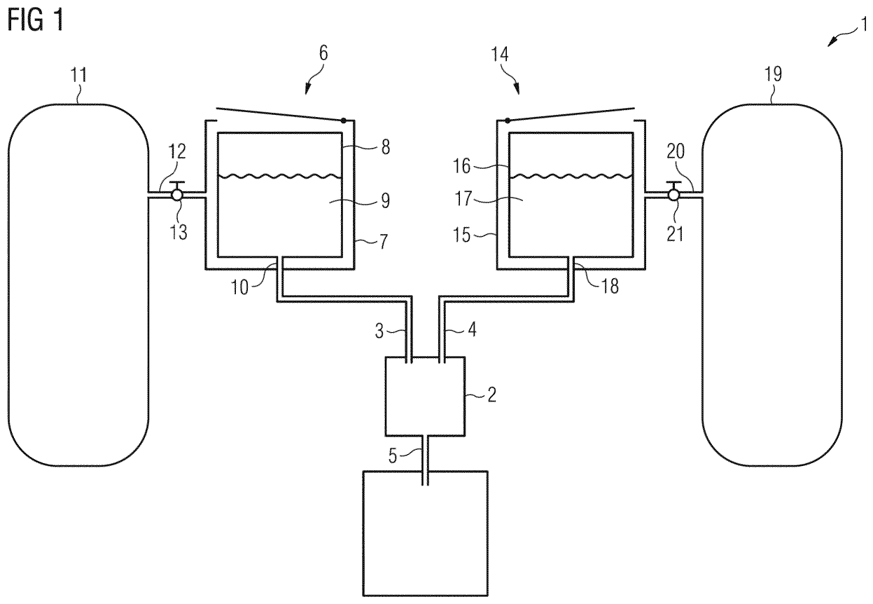

FIG. 1 shows the general setup of an apparatus according to the invention. In detail it shows an apparatus (1) for mixing two liquids, with a static mixing device (2), having a first inlet (3) for receiving the first liquid (9), a second inlet (4) for receiving the second liquid (17), an outlet (5) for discharging the liquid mixture (product), a first feed module (6) for providing the first liquid (9) to the first inlet (3). The first feed module (6) comprises a substrate chamber (7) for holding a flexible container (8), a flexible container (8) with interior space holding the first liquid (9), a conduit (10) for providing fluid communication between the interior space of the flexible container (8) and the first inlet (3), a first pressure reservoir chamber (11) for holding a pressurised gas, a connector (12) for providing fluid communication between the pressure reservoir chamber (11) and the substrate chamber (7), with a valve (13) for reversibly interrupting the fluid communication. The apparatus further comprises a second feed module (14) for providing the second liquid (17) to the second inlet (4). The second feed module (14) comprises a second substrate chamber (15) for holding a second flexible container (16), a second flexible container (16) with interior space holding the second liquid (17), a conduit (18) for providing fluid communication between the interior space of the second flexible container (16) and the second inlet (4), a second pressure reservoir chamber (19) for holding a pressurised gas, a connector (20) for providing fluid communication between the second pressure reservoir chamber (19) and the second substrate chamber (15), with a means (21) for reversibly interrupting the fluid communication.

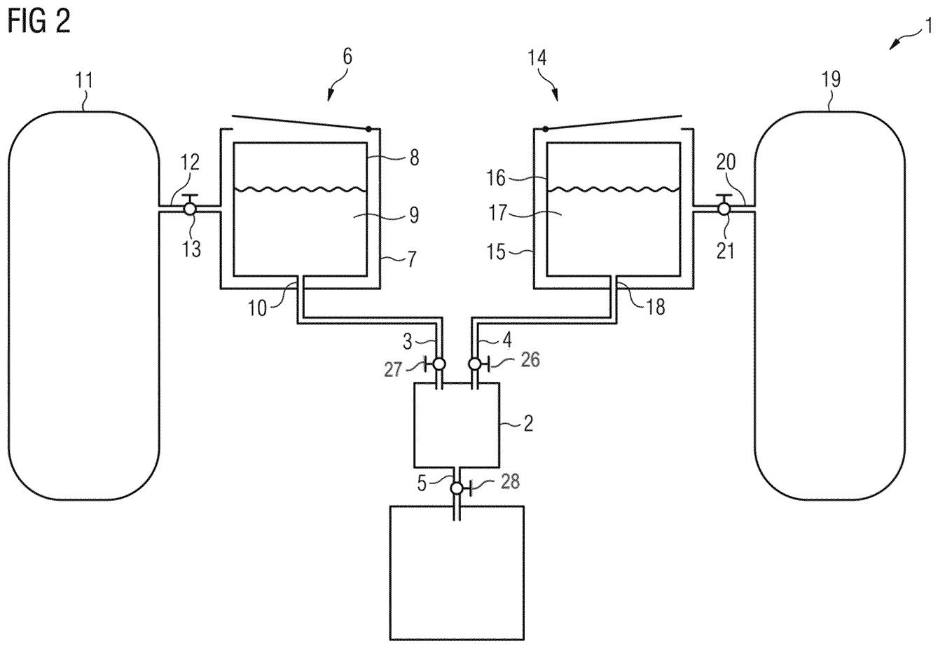

FIG. 2 shows a similar apparatus as described in FIG. 1 which additionally comprises valves (26, 27) between the interior spaces of the flexible containers (8, 16) and the inlets (3, 4) of the static mixer (2). In this embodiment, the outlet (5) comprises a means (28) for reversibly interrupting the discharging of the liquid mixture (product) from the static mixing device (2).

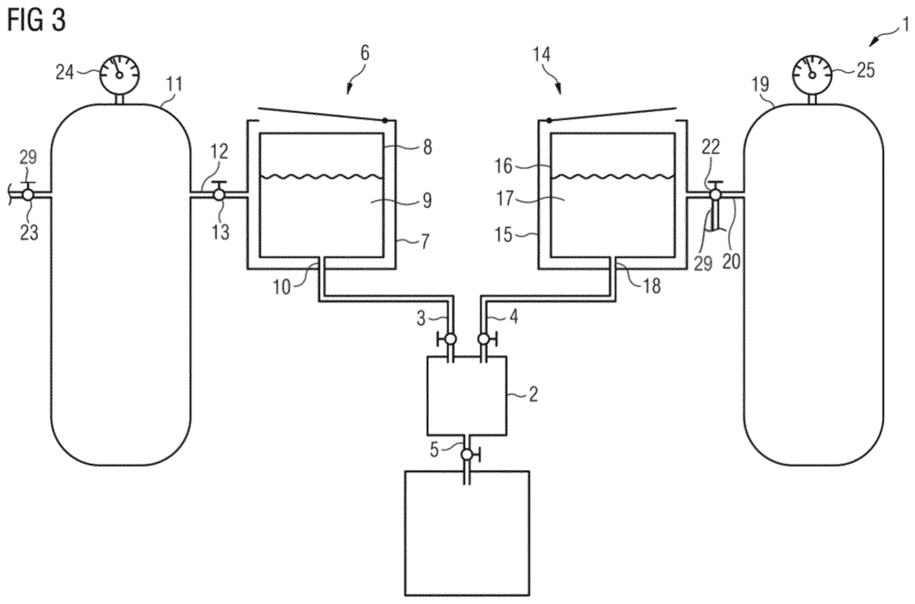

FIG. 3 shows a similar apparatus, further comprising means (24, 25) for indicating the pressure. Further, the pressure reservoir chambers (11, 19) comprise inlets (29) for pressurised gas with means (22, 23) for closing the inlet (29). In this embodiment, the means (22) for reversibly interrupting the fluid communication between second pressure reservoir chamber (19) and the second substrate chamber (15) is a three-way valve.

FIG. 4, which is not to scale, depicts an example of a jet impingement reactor (31). It comprises a reaction chamber (36) defined by the interior surface (32) of the chamber wall (33) and is substantially spherical, except for the two fluid inlets (34) and the fluid outlet (37). The fluid inlets (34) are arranged at opposite positions on a first central axis (x) of the reaction chamber (36) and point at one another. Each of the fluid inlets (34) comprises a nozzle (35), which is a plain orifice nozzle in this embodiment. The fluid outlet (37) is positioned on a second central axis (y) which is perpendicular to the first central axis (x). The distance (d) between the two nozzles (35) is substantially the same as the diameter of the spherical reaction chamber (36).

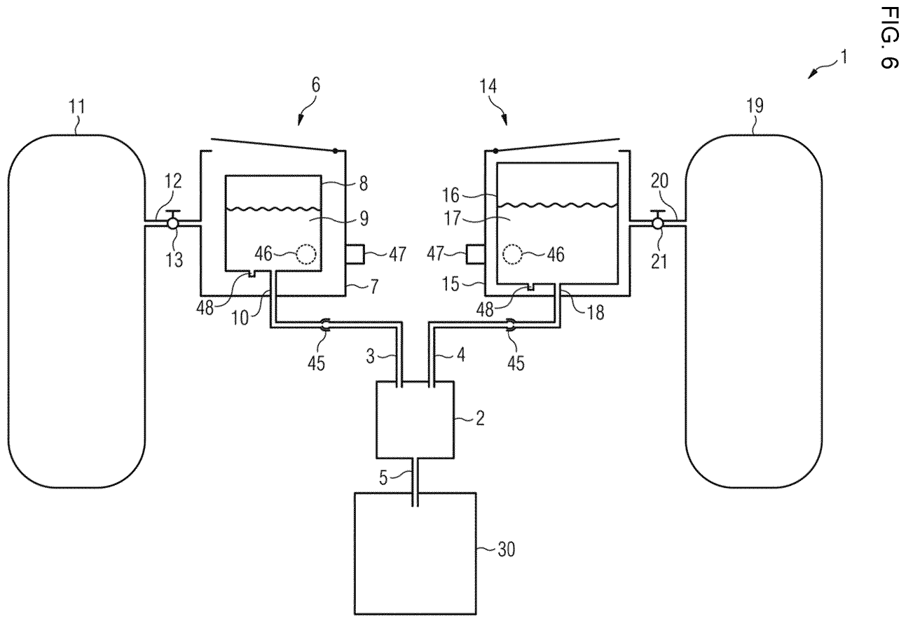

FIG. 5 illustrates an optional type of a flexible container (40) holding a first or second liquid (41). In principle, however, a flexible container (40) with the same or a very similar design may also be useful as a container for receiving the third liquid. In this case, the flexible container (40) comprises an inlet (42) with a filtration means (43) such as a sterile filter to enable the aseptic introduction of the liquid (41). Optionally, a part of the inlet (42) may be removed by thermal clamping, which closes and seals the remaining part of the inlet (42) and which may simultaneously remove the filtration means (43), prior to the introduction of the pre-filled flexible container (40) into a pressurisable substrate chamber. Moreover, an outlet (44) is provided through which the liquid (41) may flow from the flexible container (40) to an inlet of the static mixing device. The downstream end of the outlet (44) exhibits a connecting piece (45) which may engage with a complementary connecting piece, e.g., to establish a fluid connection with the static mixing device. The container further has an identification means (46), such as an RFID code.

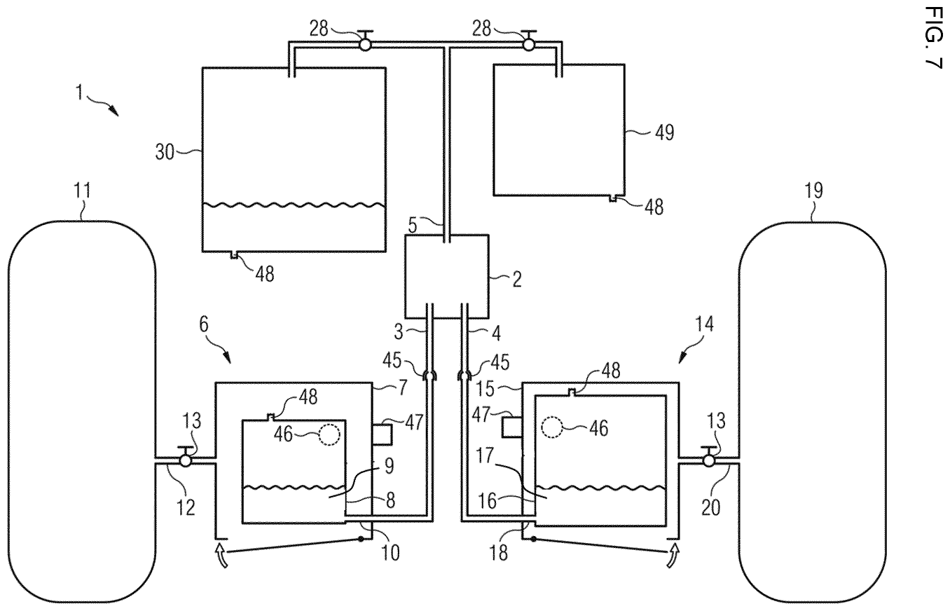

FIG. 6 shows another version of the apparatus (1) similar to that of FIG. 2, but with some further modifications. In this version, the flexible containers (8, 16) for the first and the second liquid (9, 17) have identification tags (46), such as RFID tags, and each of the first and the second substrate chamber (7, 15) has a sensor (47), such as an RFID reader, configured to read the identification tag. The flexible containers (8, 16) further comprise closed or sealed inlets (48), i.e. the structures that remain after melt sealing of the original inlets. The conduits between the flexible containers (8, 16) and the inlets (3, 4) of the static mixer (2) are arranged without valves. Engaged connecting pieces (45) are shown that help to ensure that a fluid connection between the flexible containers (8, 16) and the inlets (3, 4) is established or maintained. A container (30) for receiving the third fluid is depicted as a flexible container. The remaining features are the same as in FIG. 2.

FIG. 7 depicts a further alternative version of the apparatus (1). In this version, the overall direction of liquid flow from the flexible containers (8, 16) in the pressurisable substrate chambers (7, 15) through the static mixing device (2) to the containers (30, 49) for receiving the third liquid is upwards, i.e. against gravity, or from a lower position to a higher position. The inlets (3, 4) of the static mixer (2) are higher than the outlets (10, 18) of the flexible containers (8, 16) that hold the first and the second liquid (9, 17). The orientation of the static mixer (2) itself is such that the outlet (5) is in a higher position than the inlets (3, 4), and the inlets of the containers (30, 49) for receiving the third liquid are in a higher position than the outlet (5) of the static mixer. The first container (30) for the third liquid, which may serve as a product container, has been pre-filled with an amount of a liquid diluent. The second container (49) for the third liquid, which may serve as a waste container, is also fluidically connected with the outlet (5) of the static mixer (2), like the first container (30). A means (28) for reversibly interrupting the fluid connection with the outlet (5) of the static mixer (2) is arranged for both the first container (30) and the second container (49). Other features depicted here have already been described.

FIG. 8 depicts another version of the apparatus (1). In this case, the second container (49) for receiving the third liquid which may function as a waste container already contains a portion of the third liquid, indicating that the mixing process, i.e. steps (dd) and (ee) according to the method of the invention, has already started. In this embodiment, a means for inline particle size measurement of the third liquid is provided, comprising a sensing window (50) arranged downstream of, and in fluid connection with, the static mixing device (2), allowing the transmission of optical signals between the third liquid to an analyser (51) with a sensor capable of receiving such optical signals. The analyser (51) which is typically adapted for inline particle size measurement can communicate (e.g. electrically or wireless) with a controller (52), which is also in communication (e.g. electrically or wireless) with two means (28), such as pinch valves, for interrupting the fluid connection between the outlet (5) of the static mixing device (2) and the first (30) or second (49) container for receiving the third liquid, respectively. By the action of the controller (52), those portions of the third liquid whose particle size as measured by the analyser (51) via the sensing window (50) do not comply with the desired particle size, can be directed to the second container (49), i.e. the waste container, in that the controller (52) operates the (e.g.) valves (28) to interrupt the fluid connection of the static mixer (2) to the first container (30) but not to the second container (49). Once the third liquid has the desired particle size as measured by the analyser (51), the controller (52) can direct the third liquid into the first container (30), i.e. the product container, by operating the (e.g.) valves (28) to interrupt the fluid connection of the static mixer (2) to the second container (49) but not to the first container (30). Other features shown in FIG. 8 are the same as in previous drawings and have been explained already.

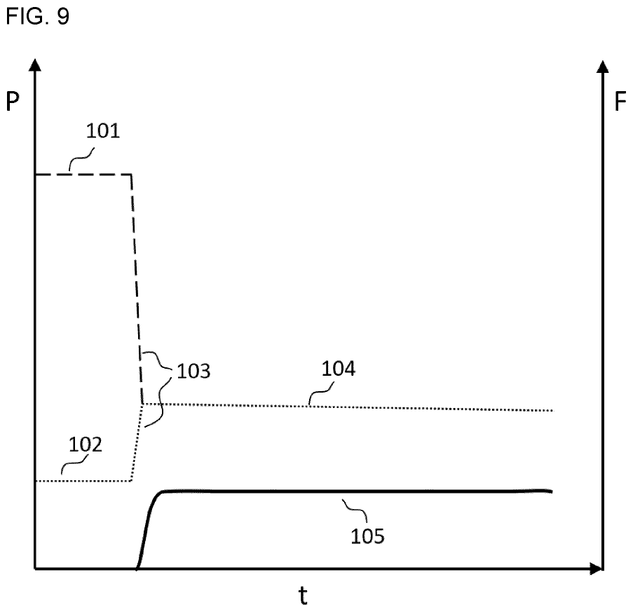

FIG. 9 shows a schematic illustration of a typical overall relationship between the pressure (P) in a pressure reservoir chamber, the pressure (P) in a corresponding pressurisable substrate chamber, and the flow rate (F) of a liquid as it is forced out from a flexible container accommodated in the substrate chamber over time (t) when conducting the method of the invention according to one embodiment. The figure is not to scale and only uses arbitrary units. Initially, i.e. before conducting step (dd) of the method, the pressure (101) in the pressure reservoir chamber which contains a pressurised gas is substantially higher than the pressure (102) in the corresponding pressurisable substrate chamber holding a flexible container with liquid. During this phase, the respective means for reversibly interrupting the fluid communication between the pressure reservoir chamber and the substrate chamber is in its closed state, and the pressure (102) in the substrate chamber may be the same as, or close to, ambient pressure. Step (dd), which may be initiated by changing the state of the means for reversibly interrupting the fluid communication between the pressure reservoir chamber and the substrate chamber from closed to open, which will cause an abrupt pressure equilibration (103) between the pressure reservoir chamber and the substrate chamber. It is noted that this pressure equilibration involves an abrupt decrease of the pressure in the pressure reservoir chamber and an abrupt increase of the pressure in the corresponding substrate chamber, which is now above the ambient pressure level. The now increased pressure (104) in the substrate chamber, i.e. the equilibrium pressure, which acts on an external surface of the flexible container holding the liquid, now forces the liquid to flow out from the flexible container towards the static mixer at a substantially constant flow rate (105). During the flow of the liquid, no further pressurised gas is introduced to the pressure reservoir chamber or the substrate chamber. The pressure (104) in substrate chamber after equilibration remains nearly constant as the volume of the liquid flowing out from the flexible container is very small compared to the total volume of the pressure reservoir chamber and the substrate chamber.

Depending on certain optional process parameters or on the type and sensitivity of pressure or flow sensors for measuring the pressure (P) and the flow rate (F), minor deviations from the overall shape of the graphs depicted in FIG. 9 may be observed when using the apparatus or conducting the process according to the invention. For example, during the abrupt pressure equilibration (103), very short initial peaks may be observed for the pressure (102) in the substrate chamber or for the flow rate (105), e.g. if the fluid paths upstream of the static mixing device are prefilled with liquid. Such short peaks may be interpreted as initial pulses or “shock waves” that travel through the liquid. They do not change the overall characteristics of the process. Moreover, instead of a very minor decrease over time of the pressure (104) in the substrate chamber after abrupt equilibration, a minor increase of the pressure (104) over time might be observed. A minor decrease could, for example, result from the small increase of the volume of the pressurised gas in the substrate chamber, whereas a minor increase could result from a small temperature increase of the pressurised gas during the process. The minor pressure changes over time may also result in very minor changes in the flow rate, even though the flow rate ratio between the first and the second liquid remains substantially unaffected. The factors that could lead to a minor increase of the pressure (104) and of the flow rate (105) over time may also substantially compensate the effect of factors that could lead to a minor decrease of the pressure (104) and of the flow rate (105) over time such that the pressure (104) and the flow rate (105) remain substantially constant after the abrupt pressure equilibration.

### LIST OF REFERENCE NUMBERS

1 Apparatus
2 Static mixing device
3,4 Inlet
5 Outlet
6, 14 Feed module
7,15 Substrate chamber
8, 16, 40 Flexible container
9, 17, 41 Liquid
10, 18 Conduit
11, 19 Pressure reservoir chamber
12, 20 Connector
13 Valve
21 Means for reversibly interrupting fluid communication
22, 23, 53 Means for closing inlet for pressurised gas
24, 25 Means for indicating pressure
26, 27 Valve
28 Means for reversibly interrupting liquid flow
29 Inlet for pressurised gas
30 Product container
31 Jet impingement reactor
32 Interior surface of chamber wall
33 Chamber wall
34 Fluid inlet
35 Nozzle
36 Reaction chamber
37 Fluid outlet
42 Inlet
43 Filtration means
44 Outlet
45 Connecting piece
46 Identification means
47 Sensor
48 Sealed inlet
49 Waste container
50 Sensing window
51 Analyser
52 Controller
101 Pressure in pressure reservoir chamber
102 Pressure in substrate chamber
103 Abrupt equilibration phase
104 Pressure in substrate chamber after equilibration
105 Flow rate of liquid

The following examples serve to illustrate the invention, however, should not be understood as restricting the scope of the invention.

### EXAMPLES

### Example 1

A prototype apparatus according to the invention was assembled and tested. The non-optimised apparatus (non-optimised e.g. with respect to minimal dead volumes) comprised, as a static mixer, a jet impingement reactor as described in co-pending European patent application 21192535.9. The substantially spherical reaction chamber had a diameter of 5 mm, and the first and the second inlet were each provided by a plain orifice nozzle having a pinhole diameter of 200 μm. Water was used as surrogate for the both first and the second liquid. The water was provided in two flexible containers, similar to infusion bags, and placed into the first and the second substrate chamber, respectively. The internal volume of the substrate chambers was approx. 10 L and the volume of water in each flexible container was approx. 500 mL. The first and the second pressure reservoir chamber each had a volume of about 20 Land was filled with pressurised air at a pressure of 15 bar. Moreover, the jet impingement reactor and the conduits for providing fluid communication between each of the two flexible containers and the respective inlet of the jet impingement reactor were pre-filled with water. The apparatus was further equipped with flow meters (Cori-Flow™) arranged in fluid conduits between the interior space of the flexible containers and the first or the second inlet of the jet impingement reactor, respectively, and with various pressure sensors.

By simultaneously opening magnetic valves positioned in the connectors between the pressure reservoir chambers and the corresponding substrate chambers, instant pressure equilibration between the pressure reservoir chambers and the corresponding substrate chambers was achieved. Pressure values were recorded once per second, and it was observed that already one second after opening the valves, an initial equilibrium pressure of about 9 bar was obtained in each substrate chamber. Until the end of the test run which lasted 43 seconds, the equilibrium pressure slightly rose to about 10 bar in each substrate chamber, probably due to a minor temperature increase during this phase. At each point in time, the pressure in the first substrate chamber was practically identical to that in the second substrate chamber.

Pressure equilibration immediately triggered the flow of water out of the flexible containers in the substrate chambers in a downstream direction, i.e. towards and through the jet impingement reactor. The flow rates were rather constant starting from about two seconds after the initial pressure equilibration: The flow rate in the first feed module increased only very slightly and evenly from about 53 to about 54 mL/min, and in the second feed module from about 54 to about 55 mL/min. In the first one or two seconds, a flow rate peak was observed which was considered an artifact caused by the initial pressure impulse traveling through the water-filled system. The very minor difference between the two feed modules is likely to be caused by minimal pinhole differences due to manufacturing tolerance, whereas the slight and technically rather negligible increase of the flow rates over time may result from the corresponding increase in pressure.

In summary, the experiment demonstrates that the apparatus is suitable to achieve an almost instant onset of flow of two liquids from flexible substrate containers into a static mixing device followed by highly controlled flow rates and flow rate ratios between the flow rates. It also demonstrates that small-scale mixing of two liquids without pumps may be performed using the apparatus.

### Example 2

A similar prototype apparatus as in Example 1 was used for mixing two model liquids which upon mixing lead to the formation of solid barium sulphate particles, except that the reaction chamber of the jet impingement reactor had a diameter of 3 mm. The first liquid consisted of about 500 mL of an aqueous solution of barium chloride, and the second liquid was about 500 mL of an aqueous solution of barium sulphate. The two liquids were provided in flexible bags which were placed into a first and a second substrate chamber having a volume of about 10 L, respectively. The first pressure reservoir chamber had a volume of 20 L and was filled with pressurised air up to a pressure of 10.9 bar. The second pressure reservoir chamber also had a volume of 20 L and was pressurised with air to 6.1 bar. Connectors between the first pressure reservoir chamber and the first substrate chamber and between the second pressure reservoir chamber and the second substrate chamber were equipped with solenoid valves. Upon simultaneously opening the valves, substantially instant pressure equilibration between each pressure reservoir chamber and the therewith connected substrate chamber was observed: For the first feed module (i.e. with the first pressure reservoir chamber and the first substrate chamber), a pressure of 7.2 bar was recorded, for the second feed module (i.e. with the second pressure reservoir chamber and the second substrate chamber), the pressure was 4.6 bar. The overpressure caused the two liquids to flow from the respective flexible containers at a total flow rate (i.e. the sum of the flow rates of the first liquid stream and of the second liquid stream) of 75.5 mL/min, with a flow rate ratio between the first liquid and the second liquid of 0.73. The liquid product (i.e. the third liquid) resulting from the mixing of the first and the second liquid in the jet impingement reactor was an aqueous dispersion of barium sulphate nanoparticles having a z-average particle size of 79.4 nm and a polydispersity index of 0.14, as measured by dynamic light scattering (DLS) using a Anton Paar™ Litesizer 500.

For evaluating the reproducibility of the mixing process, the experiment was repeated twice. In both additional test runs, the instant pressure equilibration led to similar pressures as in the first experiment, and also to a comparable product with respect to the nanoparticle characteristics, as shown in Table 1, thus demonstrating a high degree of process robustness and reproducibility.

TABLE 1

| | | | TFR | | | |
|---|---|---|---|---|---|---|
| Run | P₁ [bar] | P₁ [bar] | [mL/min] | FRR | z-Ave [nm] | PDI |
| 1 | 10.9/6.1 | 7.2/4.6 | 75.5 | 0.73 | 79.4 | 0.14 |
| 2 | 10.9/6.1 | 7.3/4.4 | 74.6 | 0.72 | 82.3 | 0.15 |
| 3 | 10.9/6.1 | 7.3/4.4 | 75.2 | 0.72 | 79.2 | 0.14 |

P₁: Pressure in pressure reservoir chambers (first/second) before equilibration; P₂: Pressure in n after equilibration (first/second); TFR: Total flow rate; z-Ave: z-average particle size; PDI: polydispersity index.

1. An apparatus for mixing a first liquid and a second liquid, said apparatus comprising:
(a) a static mixer having
a first inlet for receiving the first liquid,
a second inlet for receiving the second liquid, and
an outlet for discharging a third liquid that results from mixing the first liquid and the second liquid;
(b) a first feed module for providing the first liquid to the first inlet;
(c) a second feed module for providing the second liquid to the second inlet;
wherein each of the first and the second feed module comprises:
a substrate chamber for holding a flexible container, said flexible container having an interior space for holding the first liquid or the second liquid, respectively;
a conduit for providing fluid communication between the interior space of the flexible container and the first or the second inlet of the static mixer, respectively;
a pressure reservoir chamber for holding a pressurised gas;
a connector for providing fluid communication between the pressure reservoir chamber and the substrate chamber, wherein said fluid communication is for permitting a flow of pressurised gas from the pressure reservoir chamber to the substrate chamber such as to exert pressure on an external surface of the flexible container and to force the first or second liquid from the container into the conduit;
a means for reversibly interrupting the fluid communication between the pressure reservoir chamber and the substrate chamber, said means having an open state and a closed state;
wherein the connector and said means are arranged for achieving immediate pressure equilibration between the pressure reservoir chamber and the substrate chamber upon changing the state of said means from closed to open.

2. The apparatus according to claim 1, wherein the static mixer comprises a T-piece mixer, a Y-piece mixer, a vortex mixer, a baffle-based static mixer, a microfluidic mixing device, a multi-inlet vortex mixer (MIVM), or a jet impingement reactor.

3. The apparatus according to any one of the preceding claims, wherein the pressure reservoir chamber has a larger volume than the substrate chamber with which it is in fluid communication.

4. The apparatus according to claim 3, wherein the ratio of the volume of the pressure reservoir chamber to the volume of the substrate chamber is at least about 10, and optionally in the range from about 10 to about 100, such as about 20 to about 50.

5. The apparatus according to any one of the preceding claims, wherein the open state and the closed state are the only states of the means for reversibly interrupting the fluid communication between the pressure reservoir chamber and the substrate chamber.

6. The apparatus according to any one of the preceding claims, wherein the means for reversibly interrupting the fluid communication between the pressure reservoir chamber and the substrate chamber in its open state has a fluid path for the pressurised gas having a cross-sectional area of at least about 1 mm².

7. The apparatus according to any one of the preceding claims, wherein the connector and the means for reversibly interrupting the fluid communication between the pressure reservoir chamber and the substrate chamber comprise no pressure regulating member.

8. The apparatus according to any one of the preceding claims, wherein the means for reversibly interrupting the fluid communication between the pressure reservoir chamber and the substrate chamber is the sole means for controlling the flow of pressurised gas between the pressure reservoir chamber and the respective substrate chamber.

9. The apparatus according to any one of the preceding claims, wherein the pressure reservoir chamber comprises an inlet for pressurised gas, said inlet comprising a valve for closing the inlet, wherein said inlet is optionally independent from the connector.

10. The apparatus according to claim 9, wherein the inlet for pressurised gas is connected to a source of pressurised gas.

11. The apparatus according to any one of the preceding claims, wherein the substrate chamber of the first and/or the second feed module comprises a means for being opened and closed such as to allow an insertion or removal of the respective flexible container.

12. The apparatus according to any one of the preceding claims, wherein the conduit for providing fluid communication between the interior space of the flexible container and the first or the second inlet of the static mixer comprises an upstream end connected to the flexible container and a downstream end connected to the first or second inlet of the static mixer, wherein the downstream end is in a higher position than the upstream end.

13. The apparatus according to any one of the preceding claims, wherein the static mixer is oriented such that its outlet is in a higher position than its first and second inlet.

14. The apparatus according to any one of the preceding claims, wherein the outlet of the static mixer is fluidically connectable to a first container for receiving the third liquid, wherein said container is optionally a flexible container.

15. The apparatus according to claim 14, further comprising a means for reversibly interrupting the fluid connection between the outlet of the static mixer and the first container for receiving the third liquid.

16. The apparatus according to claim 14 or 15, wherein the first container for receiving the third liquid comprises a first and a second fluid inlet, wherein
the first fluid inlet is connectable to the outlet of the static mixer, and
the second fluid inlet is adapted for filling a quantity of a liquid diluent into said first container.

17. The apparatus according to claim 16, wherein an inline sterile filtration means is arranged upstream of the first and/or the second fluid inlet.

18. The apparatus according to any one of claims 14 to 17, wherein the outlet of the static mixer is fluidically connectable to a second container for receiving the third liquid, wherein said second container is optionally a flexible container.

19. The apparatus according to claim 18, further comprising a means for reversibly interrupting the fluid connection between the outlet of the static mixer and the second container for receiving the third liquid.

20. The apparatus according to claim 15 or 19, wherein the means for reversibly interrupting the fluid connection between the outlet of the static mixer and the first and/or second container for receiving the third liquid is a pneumatic pinch valve.

21. The apparatus according to any one of claims 14 to 20, wherein the first and/or second container for receiving the third liquid is in a higher position than the outlet of the static mixer.

22. The apparatus according to any one of claims 14 to 21, wherein the first and/or second container comprises an outlet for withdrawing the third liquid or a mixture of the third liquid with the liquid diluent.

23. The apparatus according to any one of the preceding claims, wherein the internal volume of the substrate chamber of the first feed module is different from the internal volume of the substrate chamber of the second feed module, and wherein the difference of said volumes is a factor in the range from about 1.5 to about 10, or from about 2 to about 5.

24. The apparatus according to any one of the preceding claims, wherein the static mixer is a jet impingement reactor having a mixing chamber defined by an interior surface of a mixing chamber wall, the mixing chamber having a substantially spheroidal overall shape, wherein the mixing chamber preferably comprises:
a first and a second fluid inlet, wherein the first and the second fluid inlet are arranged at opposite positions on a first central axis of the reaction chamber such as to point at one another, and wherein each of the first and the second fluid inlet comprises a nozzle; and
a fluid outlet arranged at a third position, said third position being located on a second central axis of said chamber, the second central axis being perpendicular to the first central axis; and
wherein the distance between the nozzle of the first fluid inlet and the nozzle of the second fluid inlet is the same or smaller than the diameter of the mixing chamber along the first central axis.

25. The apparatus according to any one of the preceding claims, wherein the static mixer is made of glass or plastic.

26. The apparatus according to any one of the preceding claims, further comprising a means for inline particle size measurement of the third liquid.

27. The apparatus according to claim 26, wherein the means for inline particle size measurement is located in a downstream portion of the static mixer, in the outlet of the static mixer, or downstream of and in fluid connection with the outlet of the static mixer.

28. The apparatus according to claim 26 or 27, wherein the means for inline particle size measurement comprises a transparent measuring window for allowing the transmission of optical signals from the third liquid to a sensor which is not in fluid communication with the third liquid.

29. The apparatus according to claim 28, wherein the transparent measuring window is provided in the form of a capillary made of glass or plastic.

30. The apparatus according to claim 29, wherein the capillary has an interior surface that is coated with a layer of a material exhibiting low protein or nucleic acid binding.

31. The apparatus according to any one of the preceding claims, wherein the flexible container holding the first or the second liquid is tagged with an identification means, and wherein the identification means is optionally an RFID tag.

32. The apparatus according to claim 31, wherein the substrate chamber of the first and/or the second feed module exhibits a sensor adapted for recognising the identification means, and wherein the sensor is optionally an RFID reader.

33. A method of mixing a first liquid and a second liquid, said method comprising the steps of:
(aa) providing a first flexible container holding the first liquid, said first flexible container being housed in a first pressurisable substrate chamber;
(bb) providing a second flexible container holding the second liquid, said second flexible container being housed in a second pressurisable substrate chamber;
(cc) providing a static mixer having
a first inlet for receiving the first liquid,
a second inlet for receiving the second liquid, and
an outlet for discharging a third liquid that results from mixing the first liquid and the second liquid; and
(dd) pressurising the first and the second pressurisable substrate chamber independently by means of a pressurised gas which exerts pressure on an external surface respectively of the first and the second pressurisable substrate chamber such as to force said first and said second liquid through the static mixer such as to mix said first and said second liquid; and
(ee) collecting the third liquid.

34. The method according to claim 33, wherein the pressurising step (dd) includes a sudden increase of pressure in each of the first and the second pressurisable substrate chamber from an initial pressure to a maximum process pressure within less than about 2 seconds, and preferably within less than about 1 seconds.

35. The method according to claim 34, wherein the initial pressure is approximately ambient pressure and wherein the maximum process pressure is in the range from about 1 to 16 bar, and preferably in the range from about 2 to 12 bar.

36. The method according to any one of claims 33 to 35, wherein each of the first and the second pressurisable substrate chamber is connected to a first and a second pressure reservoir chamber for holding the pressurised gas by means of a connector for providing fluid communication between the respective pressure reservoir chamber and the respective pressurisable substrate chamber, wherein a means for reversibly interrupting the fluid communication between each pressure reservoir chamber and the respective pressurisable substrate chamber is arranged, said means having an open state and a closed state; wherein, before conducting the pressurising step (dd):
the respective pressure reservoir chamber is in a pressurised state such that its pressure is about 2 to 20 times higher than the pressure of the respective pressurisable substrate chamber, and
the means for reversibly interrupting the fluid communication between the respective pressure reservoir chamber and the respective pressurisable substrate chamber is in the closed state.

37. The method according to any one of claims 33 to 36, wherein the pressurising step (dd) comprises the substeps of
(i) changing the state of the means for reversibly interrupting the fluid communication between each pressure reservoir chamber and the respective pressurisable substrate chamber from closed to open and generating a pressure equilibrium between each pressure reservoir chamber and the respective pressurisable substrate chamber within a period of not more than about 2 seconds; and
(ii) forcing essentially the entire amount of said first and said second liquid to flow from the respective flexible container through the static mixer such as to generate the third liquid over a period of at least about 5 seconds, and preferably of at least 10 seconds, such as from about 10 seconds to about 15 minutes.

38. The method according to any one of claims 33 to 37, wherein no additional pressurised gas is fed into any of the pressure reservoir chambers during steps (dd) and (ee).

39. The method according to any one of claims 33 to 38, wherein
the first liquid comprises an organic solution of one or more lipids;
the second liquid comprises an aqueous solution of a biologically active agent; and wherein
lipid nanoparticles are formed by the mixing of the first and the second liquid, wherein the biologically active agent is associated with and/or encapsulated within the lipid nanoparticles.

40. The method according to claim 39, wherein the biologically active agent is an oligo- or polynucleotide.

41. The method according to claim 40, wherein the oligo- or polynucleotide is an optionally modified mRNA molecule comprising a nucleic acid sequence encoding an antigen, in particular a tumour antigen, a viral antigen, a bacterial antigen, a fungal antigen, or a protozoal antigen.

42. The method according to any one of claims 33 to 41, further comprising a step of sterilising the static mixer, wherein the sterilising step is conducted before step (dd).

43. The method according to any one of claims 33 to 42, wherein step (ee) comprises collecting at least a portion of the third liquid in a first container for receiving the third liquid, said first container being arranged in fluid connection with the outlet of the static mixer.

44. The method according to any one of claims 33 to 43, further comprising a step of filling a liquid diluent into said first container before or after the third liquid is received in said first container.

45. The method according to claim 44, wherein the liquid diluent comprises a pH-adjusting agent, an isotonising agent, a lyophilisation aid, or any combination thereof.

46. The method according to any one of claims 33 to 45, further comprising a step of performing an inline particle size measurement on the third liquid before said third liquid is received by the first container.

47. The method according to any one of claims 43 to 46, wherein step (ee) comprises collecting at least a further portion of the third liquid in a second container for receiving the third liquid, said second container being arranged in fluid connection with the outlet of the static mixer.

48. The method according to claim 47, wherein the collecting of the further portion of the third liquid in said second container is effected by interrupting the fluid connection between the outlet of the static mixer and the first container for receiving the third liquid.

49. The method according to claim 48, comprising:
performing inline particle size measurement on the third liquid during steps (dd) and (ee);
if the inline particle size measurement gives an undesirable result, collecting the third liquid in the second container for receiving the third liquid by interrupting the fluid connection between the outlet of the static mixer and the first container for receiving the third liquid; and
if the inline particle size measurement gives a desirable result, collecting the third liquid in the first container for receiving the third liquid by interrupting the fluid connection between the outlet of the static mixer and the second container for receiving the third liquid.

50. The method according to any one of claims 33 to 49, further comprising a step of further processing the third liquid collected according to step (ee) or a mixture of the third liquid with the liquid diluent by at least one of tangential flow filtration, chromatography, freezing, or freeze drying.

51. The method according to claim 50, wherein the further processing step is conducted under aseptic conditions.

52. Use of a pressurised gas for forcing a first liquid to flow from a flexible container into a static mixer where said liquid is mixed with a second liquid such as to form a third liquid, wherein said pressurised gas is provided such as to abruptly exert a pressure of 1 to 16 bar on an outer surface of said flexible container without being in fluid communication with said first liquid.
